(19) United States
(12) Patent Application Publication
(10) Pub. No.: US 2013/0044876 A1
(43) Pub. Date: Feb. 21, 2013

(54) GENOMICS-BASED KEYED HASH MESSAGE AUTHENTICATION CODE PROTOCOL

(71) Applicants: Harry C. Shaw, Bel Air, MD (US); Sayed I. Hussein, Annandale, VA (US)

(72) Inventors: Harry C. Shaw, Bel Air, MD (US); Sayed I. Hussein, Annandale, VA (US)

(73) Assignees: NATIONAL AERONAUTICS AND SPACE ADMINISTRATION, WASHINGTON, DC (US); UNITED STATES OF AMERICA AS REPRESENTED BY THE ADMINISTRATOR OF THE

(21) Appl. No.: 13/211,432

(22) Filed: Aug. 17, 2011

Related U.S. Application Data
(60) Provisional application No. 61/411,746, filed on Nov. 9, 2010.

(51) Int. Cl. H04L 9/28

(52) U.S. Cl. 380/255

(57) ABSTRACT

Apparatuses, systems, computer programs and methods for implementing a genomics-based security solution are discussed herein. The genomics-based security solution may include reading and parsing a plaintext message comprising a string of words and assigning a lexicographic value to each word in the string to code each word in a rational number. The solution may also include assigning a letter code to each letter. The letter code for each letter may correspond with a function in molecular biology.

### CROSS-REFERENCE TO RELATED APPLICATION

This application claims the benefit of U.S. Provisional Patent Application No. 61/411,746, filed on Nov. 9, 2010. The subject matter of the earlier filed application is hereby incorporated by reference in its entirety.

The invention described herein was made by an employee of the United States Government and may be manufactured and used by or for the Government for Government purposes without the payment of any royalties thereon or therefore.

### ORIGIN OF THE INVENTION

1. Field

The present invention generally relates to encryption, and more particularly, to a keyed Hash Message Authentication Code (HMAC).

2. Background

The ability to authenticate the identity of participants in a network is critical to network security. Known methods of authentication include Public Key Infrastructure (PKI), X.509 certificates, Rivest, Shamir and Adleman (RSA), and nonce exchanges. Deoxyribonucleic Acid (DNA) has also been used as a cryptographic medium. Some systems use DNA as a one-time code pad in a steganographic approach. The steganographic approach may be desirable because DNA provides a natural template for the hidden message approach. Such methods generally pertain to inserting encrypted sequences into genomes.

### SUMMARY

Certain embodiments of the present invention may provide solutions to the problems and needs in the art that have not yet been fully identified, appreciated, or solved by current encryption technologies. For example, some embodiments of the present invention employ a DNA-inspired hash code system that utilizes concepts from molecular biology.

In one embodiment, an apparatus is configured to implement a genomics-based keyed hash message authentication code. The apparatus includes a processor and memory storing computer program instructions. The computer program instructions are configured to cause the processor to map a plaintext message stored in the memory to a reduced representation comprising an alphabet of q letters, where q is an integer. The computer program instructions are also configured to cause the processor to assign each of the q letters to a molecular representation and to convert plaintext words to numerical form. The computer program instructions are further configured to cause the processor to code a lexicographic position of each word relative to a sequence position of each word.

In another embodiment, a computer-implemented method is performed by a physical computing device. The physical computing device may be a desktop or laptop computer, a server, a database, a personal digital assistant (PDA), a cell phone, a tablet computer, a distributed system, a cloud computing system, or any computing device or combination of computing devices, as would be understood by one of ordinary skill in the art. The computer-implemented method includes reading and parsing a plaintext message comprising a string of words and assigning a lexicographic value to each word in the string to code each word in a rational number. The computer-implemented method also includes assigning a letter code to each letter. The letter code for each letter corresponds with a function in molecular biology.

In yet another embodiment, a computer program is embodied on a non-transitory computer-readable medium. The computer program is configured to cause a processor to encode a plaintext message into DNA code using word blocks and to encrypt the plaintext message with a pre-shared secret chromosome key. The computer program is also configured to cause the processor to generate sense and antisense strands based on the encrypted plaintext message.

### BRIEF DESCRIPTION OF THE DRAWINGS

For a proper understanding of the invention, reference should be made to the accompanying figures. These figures depict only some embodiments of the invention and are not limiting of the scope of the invention. Regarding the figures:

FIG. 1 illustrates a system for providing a genomics-based security protocol, according to an embodiment of the present invention.

FIG. 2 is a flowchart illustrating a method for implementing a genomics-based HMAC architecture, according to an embodiment of the present invention.

FIG. 3 illustrates a strand sequence specification in DNA.

FIG. 4 illustrates a single strand chromosome encryption scheme yielding a single ciphertext message sequence, according to an embodiment of the present invention.

FIG. 5 illustrates a dual strand chromosome encryption scheme yielding two ciphertext message sequences, according to an embodiment of the present invention.

FIG. 6 illustrates a mobile ad hoc network with trusted and untrusted nodes and routes, according to an embodiment of the present invention.

FIG. 7 illustrates a flowchart of the plaintext encoding process and the encryption and annealing process, according to an embodiment of the present invention.

FIG. 8 illustrates a Sender and Receiver protocol, according to an embodiment of the present invention.

FIG. 9 illustrates collision resistance tests for short messages, according to an embodiment of the present invention.

FIG. 10 illustrates a MANET route establishment at a slice in time, according to an embodiment of the present invention.

FIG. 11 illustrates frameshift mutations, according to an embodiment of the present invention.

FIG. 12 illustrates confusion factors in an actual DNA genome, according to an embodiment of the present invention.

FIG. 13 illustrates a conceptual example of confidentiality and authentication in E. coli using lacZ expression, according to an embodiment of the present invention.

FIG. 14 illustrates a simplified comparison between gene transcription control regions and MAC protocol, according to an embodiment of the present invention.

FIG. 15 is a flowchart illustrating a genomics-based keyed HMAC, according to an embodiment of the present invention.

FIG. 16 is a flowchart illustrating a method for implementing a keyed HMAC system based on concepts from molecular biology, according to an embodiment of the present invention.

FIG. 17 is a flowchart illustrating a protocol for message authentication, according to an embodiment of the present invention.

FIG. 18 illustrates a network architecture utilizing a Network Authentication BioID Chip, according to an embodiment of the present invention.

FIG. 19 illustrates preparation of a Network Authentication BioID Chip for an IT Biosecurity application, according to an embodiment of the present invention.

FIG. 20 illustrates a Network Access Request under an IT Biosecurity application, according to an embodiment of the present invention.

FIG. 21 illustrates a Network Access Verification under an IT Biosecurity application, according to an embodiment of the present invention.

FIG. 22 illustrates the concept of operations of the Network Authentication BioID Chip, according to an embodiment of the present invention.

FIG. 23 illustrates an implementation of a Lab-on-a-Chip to be utilized as a Network Authentication BioID Chip, according to an embodiment of the present invention.

FIG. 24 illustrates a genomics security module and its interfaces, according to an embodiment of the present invention.

FIG. 25 illustrates a MANET with users possessing a genomics security module mixed with users lacking the genomics security module, according to an embodiment of the present invention.

### DETAILED DESCRIPTION OF THE EMBODIMENTS

It will be readily understood that the components of the present invention, as generally described and illustrated in the figures herein, may be arranged and designed in a wide variety of different configurations. Thus, the following detailed description of the embodiments of apparatuses, systems, methods, and computer readable media, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of “certain embodiments,” “some embodiments.” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Some embodiments of the present invention provide a method and an apparatus configured to implement and perform security protocols at the genomics level. A DNA-inspired hash code system may utilize concepts from molecular biology. It is possible to utilize artificially created genomes to implement this concept in many embodiments. It is also possible to mix genomes from one or more species, and to mix genomes between artificial and naturally occurring species. In some embodiments, the system may be a keyed Hash Message Authentication Code (HMAC) capable of being used in secure mobile ad hoc networks. Such embodiments may be particularly useful for applications without an available public key infrastructure. Some embodiments of the present invention can be applied in traditional computer networks that utilize standard network security protocols, trusted third party authentication, and Public Key Infrastructure, as well as Mobile Ad hoc Network (MANET) situations that lack the standard network security infrastructure.

The ability to authenticate the identity of network participants is critical to network security. Bimolecular systems of gene expression “authenticate” themselves through various means such as transcription factors and promoter sequences. These systems have means of retaining “confidentiality” of the meaning of genome sequences through processes such as control of protein expression. Confidentiality is retained independently of a centralized control mechanism. Genes are capable of expressing a wide range of products such as proteins based on an alphabet of only four symbols. Some embodiments of the present invention offer practical systems of authentication and confidentiality such that independence of authentication and confidentiality can occur without a centralized third party system. Mobile Ad hoc Networks (MANETs) may thus distinguish trusted peers, yet tolerate the ingress and egress of nodes on an unscheduled, unpredictable basis.

Some embodiments of the present invention can be used to create encrypted forms of gene expression that express a unique, confidential pattern of gene expression and protein synthesis. The ciphertext code carries the promoters, reporters, and regulators necessary to control the expression of genes in the encrypted chromosomes to produce cipherproteins. Unique cellular structures can be created that can be tied to the electronic hash code in order to create biological authentication and confidentiality schemes.

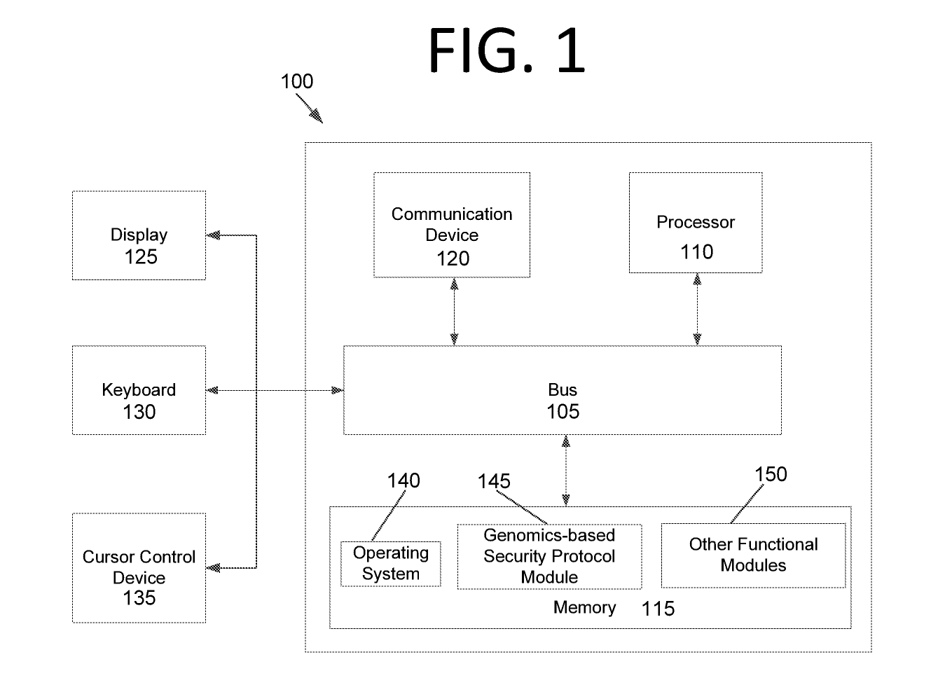

FIG. 1 illustrates a system 100 for providing a genomics-based security protocol, according to an embodiment of the present invention. System 100 includes a bus 105 or other communication mechanism for communicating information, and a processor 110 coupled to bus 105 for processing information. Processor 110 may be any type of general or specific purpose processor, including a central processing unit (CPU) or application specific integrated circuit (ASIC). System 100 further includes a memory 115 for storing information and instructions to be executed by processor 110. Memory 115 can be comprised of any combination of random access memory (RAM), read only memory (ROM), flash memory, cache, static storage such as a magnetic or optical disk, or any other types of non-transitory computer-readable media or combinations thereof. Additionally, system 100 includes a communication device 120, such as a wireless network interface card, to provide access to a network.

Non-transitory computer-readable media may be any available media that can be accessed by processor 110 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Processor 110 is further coupled via bus 105 to a display 125, such as a Liquid Crystal Display (“LCD”), for displaying information to a user. A keyboard 130 and a cursor control device 135, such as a computer mouse, are further coupled to bus 105 to enable a user to interface with system 100.

In one embodiment, memory 115 stores software modules that provide functionality when executed by processor 110. The modules include an operating system 140 for system 100. The modules further include a genomics-based security protocol module 145 that is configured to provide a DNA-inspired hash code system. System 100 may include one or more additional functional modules 150 that include additional functionality.

One skilled in the art will appreciate that a “system” could be embodied as a personal computer, a server, a console, a personal digital assistant (PDA), a cell phone, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Elements of the Genomics HMAC Architecture

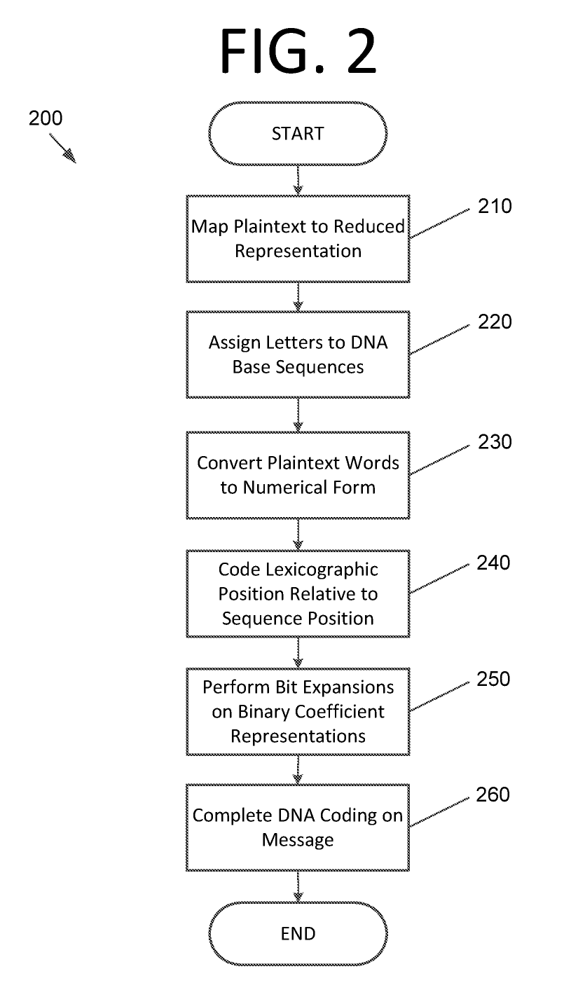

FIG. 2 is a flowchart 200 illustrating a method for implementing a genomics-based HMAC architecture, according to an embodiment of the present invention. The method may be implemented, for example, by the system 100 of FIG. 1. Plaintext is mapped to a reduced representation of q letters at 210, where q is an integer. For instance, q may be 4 for a genomic alphabet such as DNA or Ribonuleic Acid (RNA), q may be 20 for a proteomic alphabet, or q may assume other values when representing other functions in molecular biology, such as a histone code. In practice, the actual HMAC may require additional base representations beyond the four DNA bases (adenine (A), thymine (T), cytosine (C), and guanine (G)), but the minimum requirements are shown in the sets B and B′ of equations (1) and (2) below.

B_{q}={A, T, C, G} (1)

B′_{q}={T, A, G, C} (2)

B is the set of DNA bases A, T, C, and G, representing the entire alphabet of the genomic hash code. DNA bases have the property that only permitted pairs are Watson-Crick matches (A-T) and (C-G). Thus, binary representations of B and B′ sets are complimentary such that an r-bit length sequence of B_{q} and B′_{q} maintains the property identity shown in equation (3) below.

1=B_{q}^{r}⊕B_{q}^{r′}∀r=1, . . . , q (3)

Equations (1) and (2) define the sets containing the DNA bases that comprise the alphabet for the HMAC code. Equation (3) defines the relationship required for the binary representations of the members of that space. For example, in some embodiments, the “exclusive or” (XOR) product of the r^{th} bit of A and T is a one, as is true for T and A, G and C, and C and G. In other words, the value is one for permissible Watson-Crick pairings of A-T and C-G. For all other pairings, the value is 0.

Next, letters are assigned to DNA base sequences at 220. Letters with greater frequency may be assigned shorter DNA sequences to reduce the code size.

Lexicographic and DNA Representation of Plaintext

Plaintext words are then converted into a numerical form suitable for subsequent coding into the cryptographic alphabet of the required code at 230. Plaintext words are coded such that a lexicographic order is maintained between words. In other words, the numerical forms may take either integer or floating point representations. F is a function that converts the plaintext into a lexicographic numerical form. D represents the numerical form of the dictionary (i.e., lexicographically ordered set) such that D_{1, . . . n} represents the set of all words. The subset of D_{1, . . . i} represents the subset of words in the plaintext message. The function U assigns the DNA base sequence corresponding to Dᵢ as shown in equations (4), (5), and (6) below. L is the plaintext message coded into the DNA alphabet found in sets B and B′.

Dᵢ=F(Pᵢ) [symbol] Dᵢ<Dᵢ₊₁∀i<n (4)

L=U(Dᵢ,B_{q})∥U(D₂,B_{q})∥K∥U(Di,B_{q}) (5)

L′=U(D₁,B′_{q})∥U(D₂,B′_{q})∥K∥U(Di,B_{q}) (6)

Equation (4) defines each word in the message, Pᵢ, as a member of a set of all words in a lexicographically ordered dictionary. Equations (5) and (6) show the operation of the function that assigns a DNA sequence using the members of the set of DNA bases to a coding of concatenated sequences labeled L and L′. L and L′ maintain the same complimentary relationship that is a property of the individual DNA bases in the sets B_{q} and B′_{q}.

Sentence-Message Order Coding

The lexicographic position of each word relative to the sequence position of each word is coded at 240 using a system of linear equations. The system of linear equations is shown in equation (7) below.

$$[ \begin{matrix}{x}_{1} \\ {x}_{2} \\ … \\ {x}_{i}\end{matrix} ] = [ \begin{matrix}{D}_{1} & {D}_{2} & … & {D}_{i} \\ {D}_{i} & {D}_{1} & … & {D}_{i - 1} \\ … & … & … & … \\ {D}_{2} & {D}_{3} & … & {D}_{1}\end{matrix} ] [ \begin{matrix}{r}_{1} \\ {r}_{2} \\ … \\ {r}_{i}\end{matrix} ] \qquad ( 7 )$$

The system of linear equations complicates and frustrates detection of words based on frequency analysis. Multiple appearances of the same word are uniquely coded. As a minimum requirement, if there are i DNA representations in the message, and n represents a numerical sequence related to the number of DNA representations in the message (the simplest case being i=1, 2, 3, . . . , n), then the system of linear equations (7) provides the solutions for sentence-message order coding using the r^{th} position in the message to code each word of the message. The resulting coefficients are XOR'ed with the coded plaintext message to produce the ciphertext message.

Per the above, equations (5) and (6) show the operation of the function that assigns a DNA sequence using the members of the set of DNA bases to a coding of concatenated sequences labeled L and L′. This yields a series of coefficients x₁, x₂, . . . , xᵢ that are concatenated as shown in equation (8) below.

X=x₁∥x₂∥ . . . ∥xᵢ (8)

The binary representation of each coefficient undergoes bit expansions such that B_{q} or B′_{q} codes are represented in the bit stream coded by equation (8) at 250. X represents the relationship between lexicographic coding of the words and their position in the message.

Message Coding

DNA coding on the message is completed by XOR and bit expansions to maintain the DNA base coding in the binary sequence in the operation shown in equation (9) below at 260.

M=L⊕X (9)

M is the plaintext message coded into the DNA alphabet and coded again with the sentence-message coefficients. This sequence will then be subjected to encryption.

Encryption Process

To date, approximately 800 genomes have been sequenced. The human genome alone has approximately 3.2 million base pairs. The sets of genomes provide for the possibility of “security by obscurity”. Additionally, there is an infinite number of ways to use genome sequences as cryptographic keys. However, genomes have high degrees of redundancy and sequence conservation across species. Consequently, it may be advantageous for sections of genomes used as keys to be treated as one-time pads. The first step in some embodiments is to select a genome and a sequence from that genome and encode the sequence with the binary representations of B_{q} and B′_{q}.

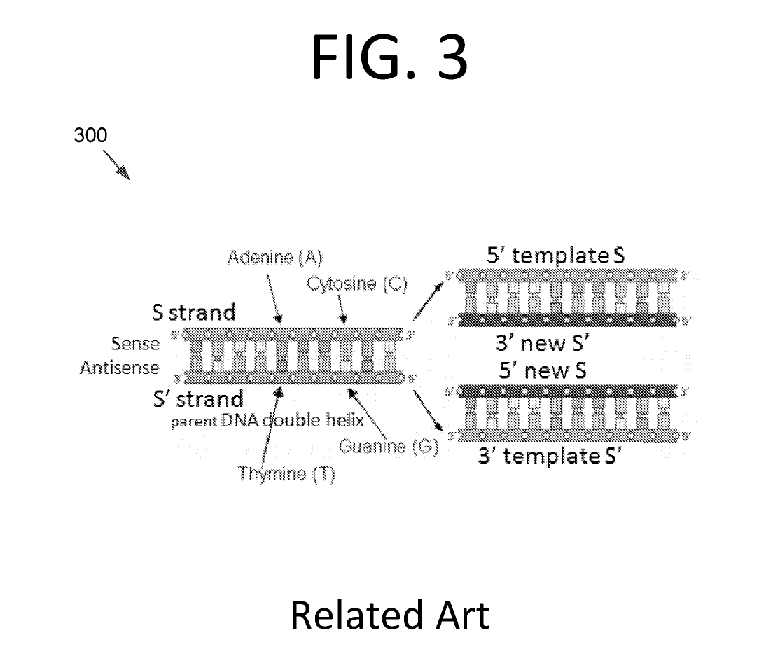

DNA includes two complementary sequences, referred to as the sense and antisense strands as shown in FIG. 3. FIG. 3 illustrates a strand sequence specification 300 in DNA. A DNA sequence has a start point called the five-prime end (5′) and an endpoint called the three-prime end (3′). In biochemistry, the 5′ and 3′ designations refer to each strand necessary for proper replication and transcription. The complements are bonded to each other base-by-base to create base pairs. The antisense strand is oriented in the 3′ to 5′ direction, relative to the sense strand. For a DNA encryption key, both sense and antisense strands can be encoded and utilized.

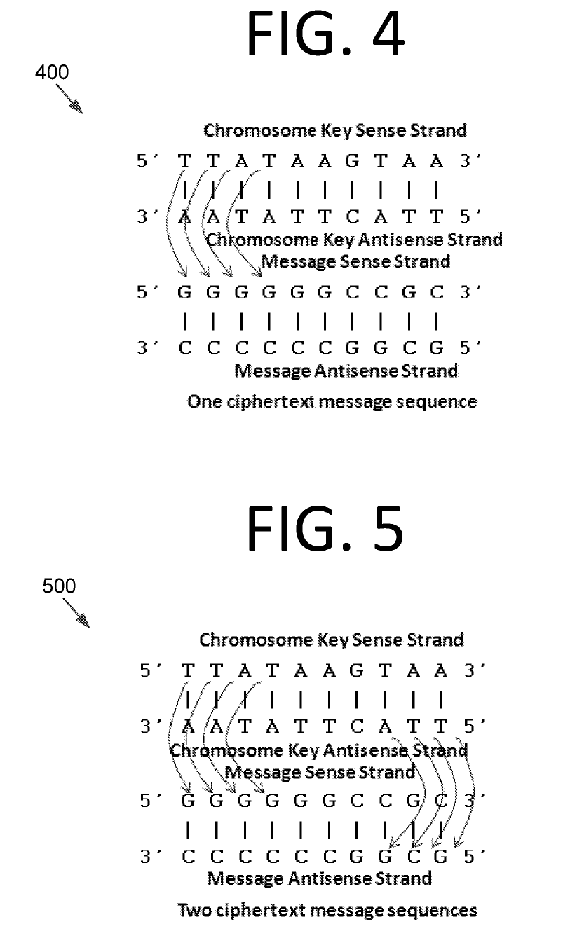

FIGS. 4 and 5 demonstrate two ways of implementing a chromosome encryption key in the HMAC scheme. FIG. 4 illustrates a single strand chromosome encryption scheme 400 yielding a single ciphertext message sequence, according to an embodiment of the present invention. The single strand chromosome encryption scheme represents the simplest scheme, in which successive bases from the key and message are XOR'ed and a single ciphertext message is produced. Encryption proceeds in the 5′ to 3′ direction using the sense strand. FIG. 5 illustrates a dual strand chromosome encryption scheme 500 yielding two ciphertext message sequences, according to an embodiment of the present invention. The dual strand chromosome encryption scheme represents a more complex scheme, in which both sense and antisense bases from the key and message are XOR'ed. Encryption proceeds in the 5′ to 3′ direction in both strands.

Mismatches and Annealing

The encryption process generates base pair mismatches that do not conform to the A-T, C-G Watson-Crick pairing rule. These mismatches are central to creating a one-way hash code in some embodiments. Subsequent to the encryption step, the mismatches are resolved through an annealing process that results in an irreversible transformation of the encryption sequence not directly traceable to the original ciphertext.

An Example DNA-Based, Keyed HMAC System

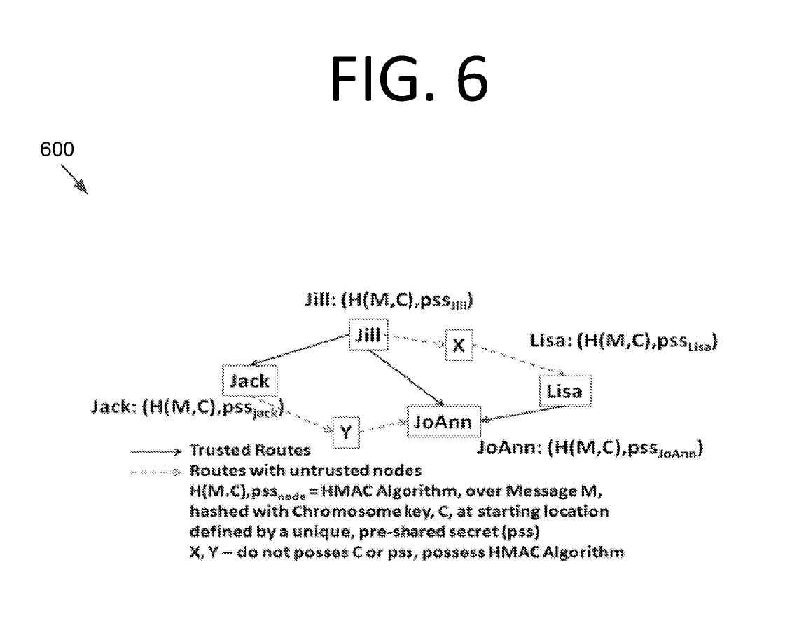

FIG. 6 illustrates a mobile ad hoc network 600 with trusted and untrusted nodes and routes, according to an embodiment of the present invention. Assume that Jack, Jill, JoAnn and Lisa wish to form a secure MANET. In the same wireless transceiver space can be found nodes X and Y, whose intentions are unknown, but who are capable of sending and receiving messages. Also assume that Jack, Jill, JoAnn and Lisa possess all of the required authentication tools: (1) a common genome, C, to use as an HMAC key; (2) a pre-shared secret (pss) unique to each party; and (3) the DNA-based HMAC algorithm.

Consider two authentication scenarios. In the first scenario Jack, Jill, JoAnn and Lisa send and receive cleartext messages using the DNA-based HMAC authentication. If the receiver is not the intended destination, the receiver rebroadcasts the message with his or her hash and the process continues until the message reaches the intended receiver or until a message time-out period elapses. X and Y also receive the cleartext messages and hash codes. X and Y may possess the algorithm. However, if X and Y wish to substitute a new message with a valid hash code, or forward the message and have the message accepted by the network members, X and Y have to create a valid hash code and checksum, which requires knowledge of the chromosome sequence and valid pre-shared secrets known to the other MANET nodes. The MANET members may change their pre-shared secrets on a pre-established basis to thwart a brute force attack to derive the pre-shared secret from the hash code.

In the second scenario, Jack, Jill, JoAnn and Lisa wish to establish a trust relationship before exchanging sensitive information across a MANET. In this case, the participants utilize a confidentiality (encryption) protocol for the messages and establish a chain of custody using keyed HMAC authentication. A hash chain of hash codes is established such that each recipient can determine the origin and subsequent hops of the message. In this case, X and Y cannot read the plaintext and the hash code transcript may be encrypted and compressed with the ciphertext.

Genomic Hash Code Properties

Table 1 below summarizes the properties of an example hash code against the requirements for an ideal hash code.

TABLE 1
GENOMIC HASH CODE PROPERTIES

| Property | Compliance |
|---|---|
| Produces a fixed length output | 2560 bits |
| Can be applied to a block of data of any | Yes |
| length | |
| H(x) is relatively easy to compute for any | Yes: 12 step process for |
| message x | hash code |
| One-way property: for any h, it is | To be determined |
| computationally infeasible to find H(x) = h | |
| Weak collision resistance: for a set of xᵢ | Yes |
| messages, with y ≠ x, for all i, no | |
| H(y) = H(xᵢ) for all i | |
| Strong collision resistance: for any x, | No: messages ≦512 bits |
| with y ≠ x, no H(y) = H(x) | require padding |

Initialize and Perform Lexicographic and DNA Process

The plain text message is read and parsed into 3-word blocks (3WB). In other words, take each word in the string, assign it a lexicographic value of x.yyyy . . . y where x=1, . . . , 26 corresponding to the first letter of the word and subsequent letters are assigned to each successive decimal place until the entire word is coded as a rational number. A DNA letter code is assigned to each letter. Most common English alpha characters use 2-letter codes, the rest use a 3-letter code as shown in Table 2 below.

TABLE 2
SAMPLE OF ALPHA TO DNA CONVERSION CODES

| α | DNA |
|---|---|
| A | GC |
| B | TGT |
| C | TC |
| D | GT |
| E | TA |
| F | ACC |
| G | TT |
| H | AC |
| I | AA |
| J | AAG |
| K | ACT |
| L | AT |
| M | CG |
| N | TG |
| O | AG |
| P | GA |
| Q | CCT |
| R | CC |
| S | GG |
| T | CA |
| U | CT |
| V | CTG |
| W | CAC |
| X | GTA |
| Y | GTT |
| Z | TAG |

The column labeled “α” is the English alphabetic character adjacent to its DNA code equivalent. As an example, the short phrase “jump out windows” is shown in its lexicographic and DNA assigned forms in Table 3 below.

TABLE 3
PLAINTEXT TO LEXICOGRAPHIC ORDER AND
DNA LETTER CODES

| | Conversion | | |
|---|---|---|---|
| | | Lexicographic | DNA |
| # | Plaintext | Conversion | Conversion |
| 1 | jump | 10.211316 | AAGCTCGGA |
| 2 | out | 15.2120 | AGCTCA |
| 3 | windows | 23.9144152319 | CACAATGGTAGCACGG |

Binary Representation of the DNA Bases

The four DNA bases (A, T, C, G) are represented by binary sequences (0011, 1100, 1001, 0110). The remaining 12 four-bit sequences code for transitional base sequences that are used to anneal mismatches in the encryption process as shown in Table 4 below.

TABLE 4
ENCRYPTION AND ANNEALING TABLE

| Key | M | Result | Anneal | Key | M | Result | Anneal |
|---|---|---|---|---|---|---|---|
| A | T | T | G | C | G | G | A |
| A | A | gA | C | C | A | aA | C |
| A | C | gC | T | C | C | aC | G |
| A | G | gG | A | C | T | aT | T |
| T | A | A | T | G | C | C | C |
| T | G | cC | G | G | A | tA | G |
| T | C | cG | A | G | G | tG | A |
| T | T | cT | C | G | T | tT | T |

The “Key” column represents the base in the chromosome encryption key. The “M” column represents the corresponding base in the DNA coded message. The “Result” column represents the results of encrypting the key onto the message. The “Anneal” column represents the final ciphertext base. In an operational system, all codes may be significantly lengthened to thwart brute force attacks.

Encryption, Mismatches and Annealing

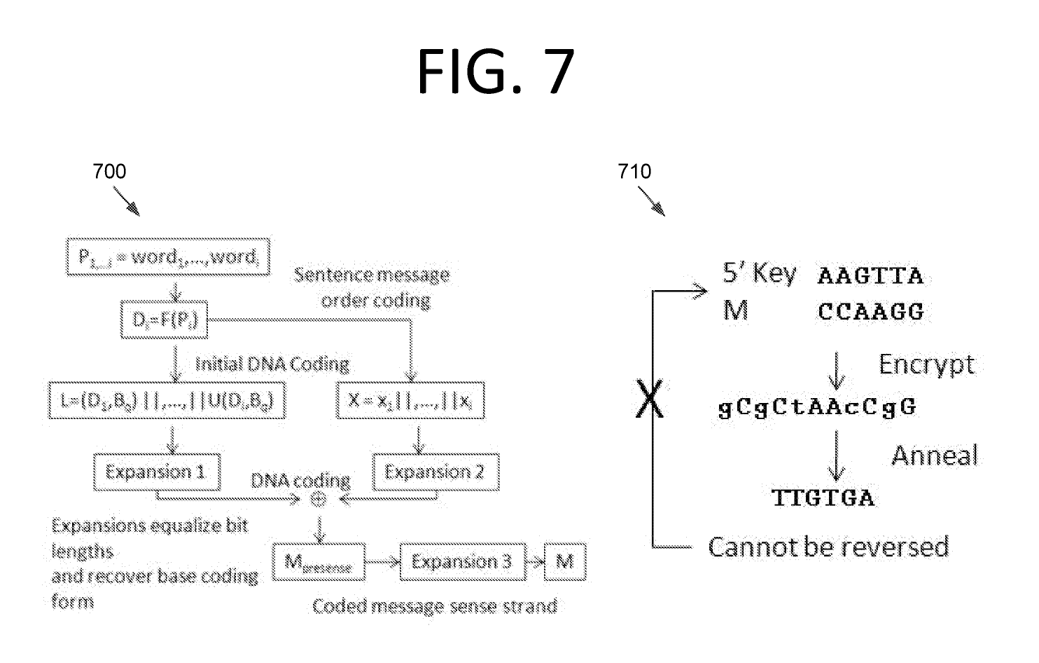

FIG. 7 illustrates a flowchart of the plaintext encoding process 700 and the encryption and annealing process 710, according to an embodiment of the present invention. Each base in the chromosome is XOR'ed against the corresponding base in the message. If the base in the message is the complement of the base in the chromosome, the base in the message is copied to the encrypted output string and then altered to a new base in the annealed output string. If the base in the message is not the complement of the base in the chromosome, a transitional base, whose value depends upon the mismatch, is written to the encrypted output string. The 5′ base always determines the change in the other strand in this embodiment. Consequently, a 5′ G mismatch always codes for a 3′ transitional base. This feature allows tracking of point mutations and provides a future expansion capability for mutations. The annealing process also alters the encrypted result by transforming the positions that are not mismatches.

Cryptographic Genome

Mycoplasma genitalium G37 (National Center for Biotechnology Information accession number NC000908.2) is a bacterial genome used as an encryption key in this example system. There are a number of characteristics of M. genitalium that make it a good candidate as an encryption key base. It is small (it may be the smallest, self-replicating genome). M. genitalium has 580,070 base pairs with 470 predicted coding regions. M. genitalium also has a low G+C content of 34%. A random, uniform distribution of base pair content would provide for 50% G−C pairs and 50% A-T pairs. This feature provides some testability advantages. The genome contains 470 predicted protein coding regions, which is a manageable number of potential cipherproteins. Knowledge of the genome coding characteristics is important in selecting and utilizing genomes as cryptographic keys. Approximately 62,000 base pairs are being utilized from the M. genitalium genome for this example HMAC.

Protocol for Message Authentication

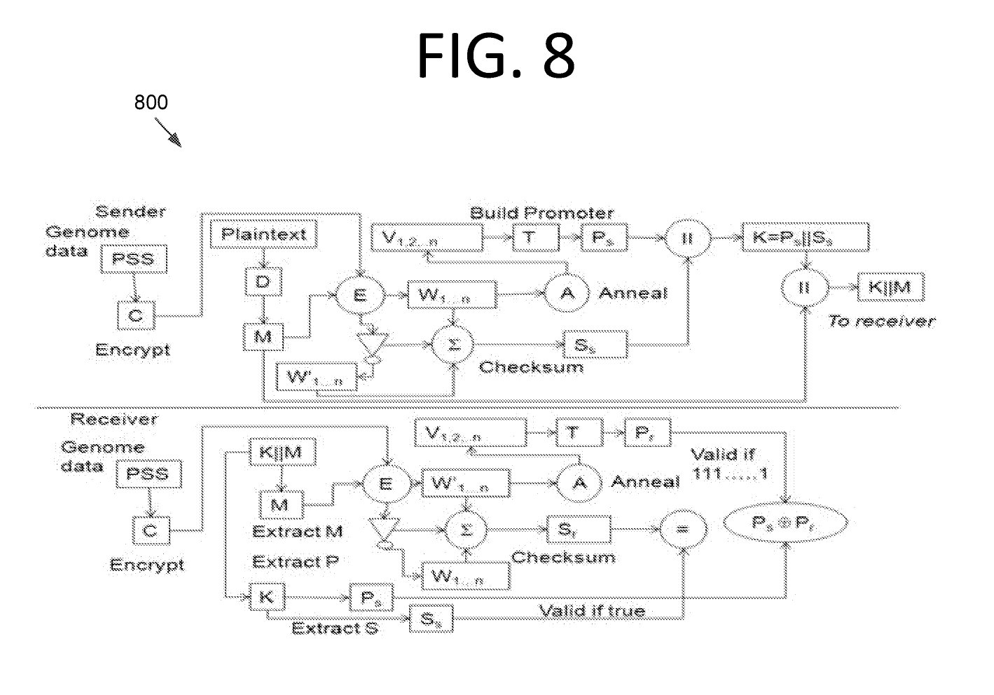

The process is as follows: (1) encode the plaintext message into DNA code (pre-sense message) 3 words at a time (3 word blocks—3WB); (2) encrypt with a pre-shared secret chromosome key and generate sense and antisense strands; (3) use different chromosome segments to encrypt each 3WB for increased key confidentiality; (4) combine sense and antisense strands to create a checksum (S); (6) anneal the sense strand (Sender) or the antisense strand (Receiver) removing the transitional bases in the 3WBs; (7) concatenate the first 64 DNA bases from the first nine 3WBs to create the Promoter (P); and (8) append the checksum to the Promoter. The Promoter ∥ checksum is the Hash Code, K (2560 bits long). The sender and receiver processes are summarized in FIG. 8, which illustrates a Sender and Receiver protocol 800, according to an embodiment of the present invention.

The Receiver extracts the Promoter and checksum from the message. The hash code computed at the receiver must have the complement of the Promoter sequence and an exact match of the checksum. Sender and Receiver must have the pre-shared secret of the genome, and the location of the first base of the sequence.

Short Message Performance

A critical factor in determining the goodness of a hash code is the ability to satisfy criteria four and five from Table 1 above. A hash code algorithm should not produce identical hash code outputs for two or more different messages. Performance of short messages was evaluated for soft and hard collision resistance for some example embodiments. The number of MAC verifications, R, required to perform a forgery attack on an m-bit MAC by brute-force verifications is shown in equation 10:

R=2^{m-1}+(2^{m-1}−1)/2^{m}≈2^{m-1} (10)

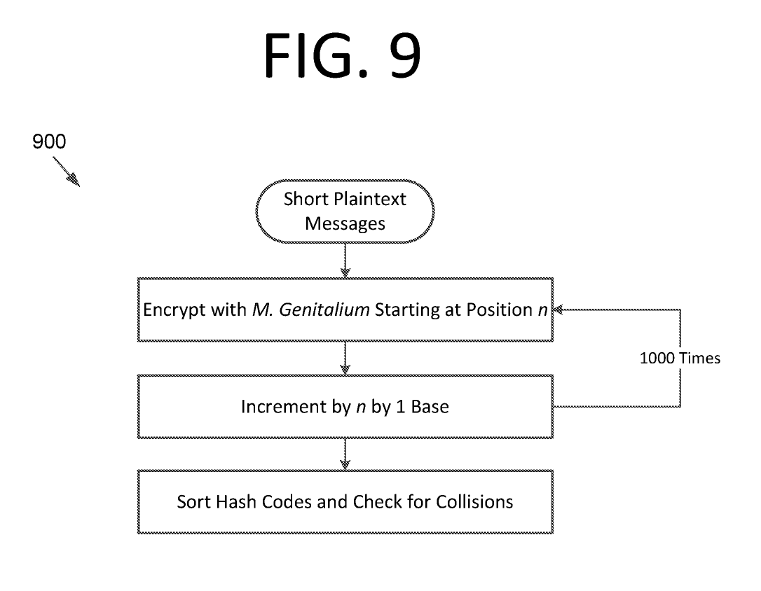

The variable R is an approximate upper bound to the brute-force verification limit. Short messages were repeatedly hashed using over different cryptographic sequences to look for collisions. The process is shown in FIG. 9, which illustrates collision resistance tests 900 for short messages. Table 5 below summarizes the results of those tests.

TABLE 5
SAMPLE OF HASH CODE COLLISIONS

| | | Hash | Total Hash | | |
|---|---|---|---|---|---|
| | Message | Code | Code | Total C/S | |
| Plaintext | Length | Length | Collisions | Collisions | R |
| z | 1 | 22 | 466 | 403 | 2097152.5 |
| ly | 2 | 30 | 255 | 214 | 536870912.5 |
| cat | 3 | 36 | 136 | 109 | 34359738369 |
| vent | 5 | 64 | 0 | 0 | 9.22337E+18 |
| aeiou | 6 | 64 | 0 | 0 | 9.22337E+18 |
| jump out windows | 16 | 64 | 0 | 0 | 9.22337E+18 |
| jump out windows | 59 | 256 | 0 | 0 | 5.7896E+76 |
| jump out windows | | | | | |
| jump out windows | | | | | |
| jump out | | | | | |
| the 123 of my fields | 201 | 576 | 0 | 0 | 1.2367E+173 |
| are very large please | | | | | |
| require all personnel | | | | | |
| to take their | | | | | |
| equipment with | | | | | |
| them for the work to | | | | | |
| be performed in | | | | | |
| 365777 small | | | | | |
| increments it will be | | | | | |
| good to get practice | | | | | |
| on these tasks | | | | | |

The single letter message exhibited 403 checksum collisions and 466 hash code collisions. Chromosomes have a high degree of redundancy and repetition. Accordingly, short messages generally require padding to eliminate hash code collisions. These statistics utilize different transcripts on the same message to identify potential collisions. The statistics should be indicative of the potential for multiple messages to produce the same hash code from a single transcript. For secure authentication purposes, this code should be implemented with higher level protocols that would block a brute force attack and not reuse genome sequences for authentication. The code should also move the starting point in the genome to widely separated start positions to prevent an attacker from guessing the encryption sequence.

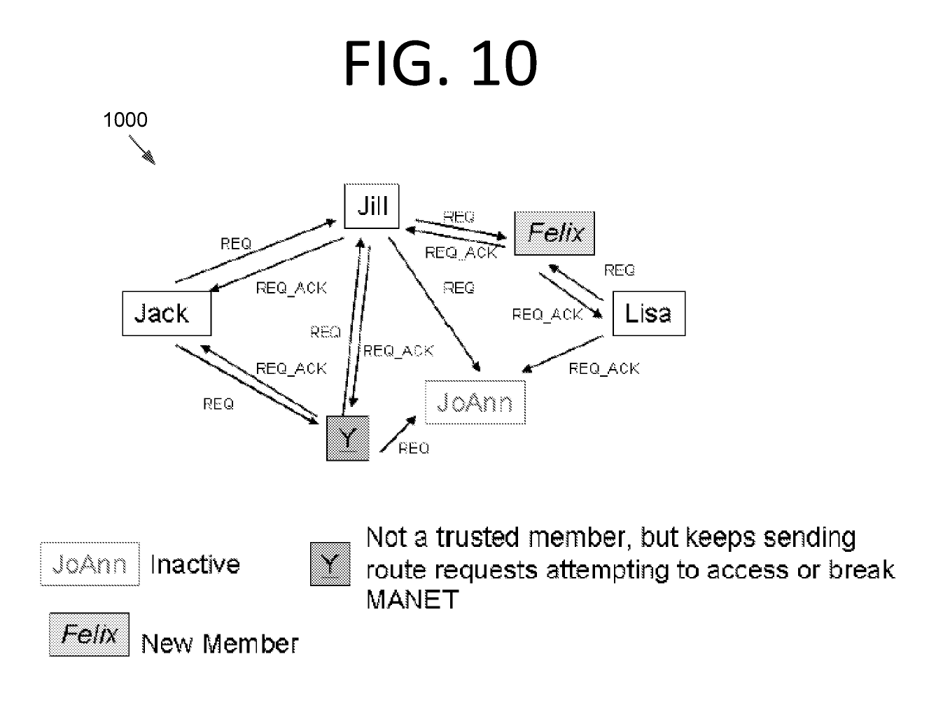

A hash code should be secure against the possibility that the cryptographic key, in this case the original genome sequence, cannot be recovered from the hash code. FIG. 10 illustrates a MANET route establishment 1000 at a slice in time, according to an embodiment of the present invention. The MANET is a small MANET example for developing trust metrics. Assume Jack is broadcasting forward requests to establish a link with Lisa and Lisa is broadcasting return route requests to Jack to establish a return link. Jill is relaying route requests in both directions. Felix wishes to join the MANET. Each node is capable of dynamically appearing and disappearing from the network at will via application of a dynamic source routing protocol. Each node can also take the role untrusted/unknown trust or trusted depending upon the situation. Source and Destination should determine the trustability of a potential route through some quantitative means. In this case, successful forward and return route requests (FREQ, RREQ) and route delays are used to create the trust metrics. The sources and destinations can set the minimum level of trust for routes via a dynamic fitness algorithm.

To establish Felix as a trusted member, Felix relays forward REQs from Jack destined for Lisa and return REQs from Lisa destined for Jack with Felix's DNA HMAC authentication attached. JoAnn does not respond to route requests and those requests time-out.

Y is a malfeasor attempting to breach the network by sending route requests with counterfeit DNA HMAC authentication and analyzing received DNA HMACs for vulnerabilities. Assume that when Y sends a counterfeit route request, genuine nodes respond with a negative acknowledgement attached to a genuine authentication code. The questions to be answered are: (1) can Y establish a counterfeit authentication code (hash+checksum) for the current session (however a session is defined); and (2) can Y utilize the stolen information to recover information that might be useful for a future network breach.

If Y can recover the original cryptographic sequence, or determine the genome and genome location that a cryptographic key was taken from, Y may be able to forge a valid hash code. This could be problematic for a cryptographic sequence due to the high degree of redundancy in all genomes. For this application, the hash code should be evaluated against the cryptographic key to ensure the hash code has the proper characteristics of diffusion and confusion.

Mutation Effects, Fitness, Diffusion and Confusion

Life is generally intolerant of a high mutation rate in its genetic code. Ribonucleic acid (RNA) viruses have the highest mutation rate of any living species, 10⁻³ to 10⁻⁵ errors/nucleotide and replication cycle. The human DNA mutation rate has been approximated to be on the order of 10⁻⁸ errors/nucleotide and generation. Injection of mutations into DNA encrypted messages is an approach to improving the encryption process. Because of the dynamic, evolutionary nature of this approach, potential intruders must continually intercept decoding instructions between source and destination. Missing one generation of genome decryption information seriously corrupts the analysis process. Missing multiple generations eventually renders previous decryption analyses useless.

In evolutionary biology, fitness is a characteristic that relates to the number of offspring produced from a given genome. From a population genetics point of a view, the relative fitness of the mutant depends upon the number of descendants per wild-type descendant. In evolutionary computing, a fitness algorithm determines whether candidate solutions, in this case encrypted messages, are sufficiently encrypted to be transmitted. This DNA encryption method uses evolutionary computing principles of fitness algorithms to determine which encrypted mutants should be selected as the final encrypted ciphertext. Two parameters, Diffusion and Confusion, are being used as the basis of the fitness criteria. Diffusion and Confusion are fundamental characteristics of ciphers. They may be described as follows:

Diffusion: any redundancy or patterns in the plaintext message are dissipated into the long range statistics of the ciphertext message.

Confusion: make complex the relationship between the plaintext and ciphertext. A simple substitution cipher would provide very little confusion to a code breaker.

The challenge is to create a set of FREQ and RREQ messages that hash into codes with a high degree of Diffusion and Confusion. One strategy for attacking the authentication message is to generate long strings of zeros and identify the correct code for the non-zero positions. If a message generates long strings of zeros, the message may be particularly vulnerable to a key recovery attack because the attacker can reduce the number of bit matches required by the length of zero bit blocks. Table 6 below summarizes test results of 1000 trials on messages consisting of zeroes and spaces against the genome.

TABLE 6
TEST RESULTS ON REDUNDANT STRINGS OF
ZEROS MESSAGES

| Length of 0's in Plaintext | Number of Collisions after 1000 Trials |
|---|---|
| 64 | 0 |
| 96 | 0 |
| 192 | 0 |

As can be seen from Table 6, no collisions were identified. The hash code may be tested against all other single character strings to identify patterns. A sample hash code of a string of 192 zeros is shown below in Table 7.

TABLE 7
SAMPLE HASH CODE STRING OF 192 ZEROS

| Checksum | DNA Hash Code |
|---|---|
| 10437404 | AATTCTAAGTTCCCGCCCGTCGGTCCGCCGCCC |
| | GTCCGGTCCGCCGCCCGTCCCGGTCCGCCGCA |
| | ATCTCAATTCTCGCCCGTCGGTCCGCCGCCCGT |
| | CCGGTCCGCCGCCCGTCCCGGTCCGCCGCCAA |
| | CTCCAATCTTGCCCGTCGGTCCGCCGCCCGTCC |
| | GGTCCGCCGCCCGTCCCGGTCCGCCGCCCAAT |
| | CCGAACTTCCCCGTCGGTCCGCCGCCCGTCCG |
| | GTCCGCCGCCCGTCCCGGTCCGCCGCCCGAAC |
| | CGTAATTCTCCGTCGGTCCGCCGCCCGTCCGGT |
| | CCGCCGCCCGTCCCGGTCCGCCGCCCGTAACG |
| | TTAATCTTCGTCGGTCCGCCGCCCGTCCGGTCC |
| | GCCGCCCGTCCCGGTCCGCCGCCCGTCAAGTT |
| | CAACTTTAATCCGAACTTCAATCGTAACGTTA |
| | ATCTTTCGTTTAAGTTCAACTTTAATTAATTCT |
| | AATTTCAACCGTAATTCTAACGTTAAGTTCAAC |
| | TTTCGTTTCAATTCTAATTTCAATC |

Next the hash codes were compared to the original cryptographic keys to evaluate Diffusion and Confusion. Table 8 below displays four mutation samples from 50 combinations of hash codes on the message “jump out windows” with encryption keys from the genome.

TABLE 8
SAMPLE MUTANT ENCRYPTIONS FOR HASH CODES
AND DNA ENCRYPTION KEY FOR MESSAGE
“JUMP OUT WINDOWS”

| | 64 Base Pair Hash | |
|---|---|---|
| ID | Code | Cryptographic Key |
| Mutant | AAAAAATGATGGTCCGCC | TAAGTTATTATTTAGTAAGTTAT |
| 4 | AGTGCCCGGCTCTCCAATG | TATTTAGTTAAGTTATTATTTAG |
| | CCTGAATCAGATGGAGAG | TTTAAGTTATTATTTAGT |
| | ATTCTGGC | |
| Mutant | AAAAAACGATGGCTGGCG | TTATAAGTTATTATTTAGTAAGT |
| 10 | ATCTCTCCGTTCCCGTAAC | TATTATTTAGTTAAGTTATTATT |
| | TCCTGAAGGATAGCTATA | TAGTTTAAGTTATTATTT |
| | GATTCCCTC | |
| Mutant | AAAAAAGGAGGGCGGGCC | AAGTTATTATTTAGTTAAGTTAT |
| 23 | AGTGCTCCGGCTCTTCAAT | TATTTAGTTTAAGTTATTATTTA |
| | CGCGTAAGTAGATCCACA | GTTATAAGTTATTATTTA |
| | GAGTGTCTG | |
| Mutant | AAAAAAGGAGGTTTGTGT | GTTAAGTTATTATTTAGTTTAAG |
| 25 | AGCGTTTGGGCCCTCGAAC | TTATTATTTAGTTATAAGTTATT |
| | CGGCGAAGGAGAGGGAGA | ATTTAGTTAATAAGTTAT |
| | TATCTTCCC | |

The process was run on 1000 message combinations at a time. Mutants 4 and 25, for example, would likely be particularly poor fits due to the number of consecutive matches between the hash code and encryption key. Mutant 10 has only one match of two consecutive bases and fewer than ¼ of the bases are identical between the hash code and key. Each position in the hash code has a 1 of 4 chance of randomly matching the same location in the encryption key. The confusion metric counts the number of 2-base, 3-base, 4-base and 5-base consecutive matches between the hash code and the key. Each combination actually represents a mutant message, which can be further evaluated via a genetic algorithm. One of the major advantages of this system over a conventional encryption system is the ability to provide a set of encrypted outputs, from which the most fit (i.e., best) member can be selected.

Intronic Sequence Padding and Potential Frameshift Mutations can Increase Cryptographic Hardness

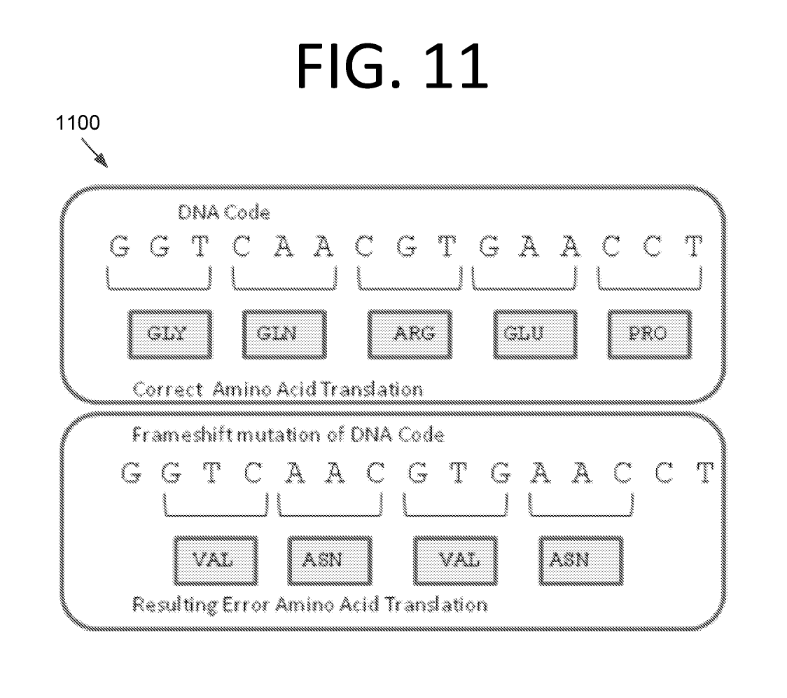

Padding short messages and short words may be a means to decrease collisions and reduce the likelihood of successfully forging messages. Adding padding to the front of messages as well as the end and padding short words makes it more difficult for an attacker to find the start of the coded message sequence. The analogy in molecular biology is the frameshift mutation, in which changing the starting position for a single nucleotide can result in a completely different protein sequence, as shown in the frameshift mutations 1100 of FIG. 11. The mechanics of DNA transcription in cells rely on a number of properties to identify the nucleotide triplet sequence that actually transcribes to mRNA, which translates to a protein. Some of the mechanics are thermodynamic and biochemical in nature, such as DNA folding, binding to transcription factors, and chromatin relaxation in eukaryotes. Some of the mechanics are sequence related. Four types of sequences and mechanisms from molecular biology are directly relevant to this discussion:

Start codon (usually ATG): specifies the transcription start site (i.e., the three letter sequence that ultimately specifies the first amino acid in the protein to be translated).

Stop codon: (TAA, TGA, TAG) to end transcription.

Promoters: the function of promoters is different in prokaryotes and eukaryotes, but as a general statement, the promoter is the sequence of nucleotides necessary to locate the transcription starting point. In eukaryotic genes that contain a promoter, the sequence often contains the letters “TATA”—hence, the term “TATA box”.

Enhancers: in eukaryotes, a variety of sequences upstream and downstream from the transcription site provide binding sites for transcription factors (proteins) necessary to enhance protein expression.

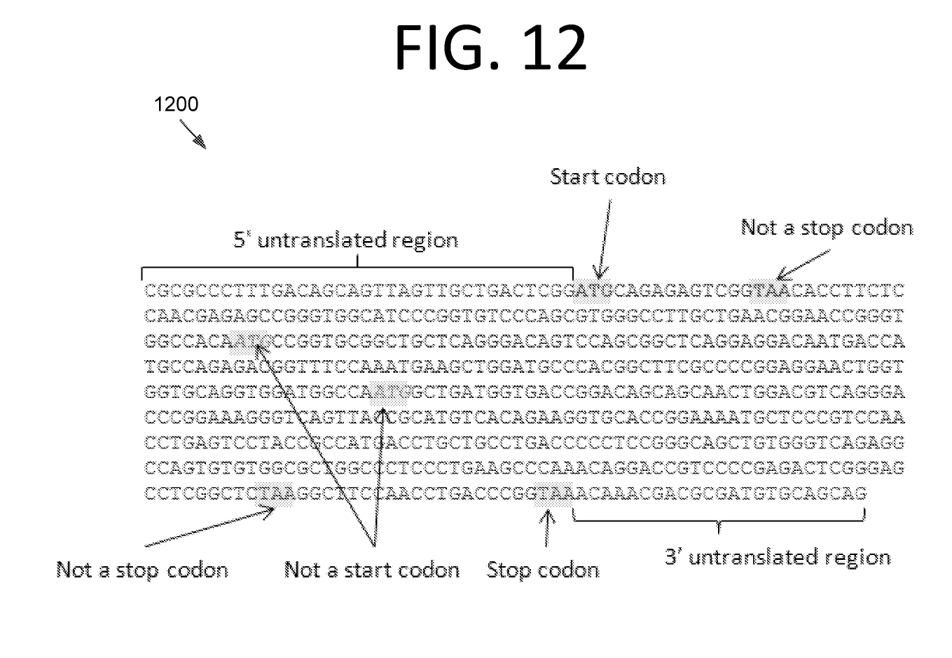

The transcription (decryption) of DNA uses these sequences as markers for process control. However, the sequences can have multiple interpretations. ATG within a gene codes for the amino acid methionine, but at the start of a gene it is a start codon. All instances of TATA do not signify a promoter. These ambiguities provide DNA with its own version of adding Diffusion and Confusion, and the analyst must fully understand the rules and mechanisms of transcription. In fact, research in gene expression starts with unambiguously identifying the actual gene sequence that codes for proteins (in eukaryotes, this is called the exon region) from intervening sequences that are untranslated regions that do not code for proteins (intron regions). This is shown in FIG. 12 for the human gene hspB9 1200, which codes for heat shock protein B9 (Ensembl ENSG00000197723). Referring back to FIG. 11, transcription from a different start site would yield a different outcome—one that is possibly fatal to the organism. Padding creates introns spread throughout the message (exon).

The same confusion and diffusion factors would apply when crafting DNA coded messages for the electronic domain that will be later instantiated into actual genomes. The ciphertext must be capable of meeting the requirements of the cryptographic hardness in the electronic domain while producing a ciphertext that can be reliably integrated into a cellular genome via standard techniques, transcripted into RNA, and translated into the appropriate cipherprotein. Decryption (expression) of the cipherprotein gene occurs in response to specific decryption instructions hidden within the electronic domain ciphertext.

Relationship Between Cryptography and Gene Expression

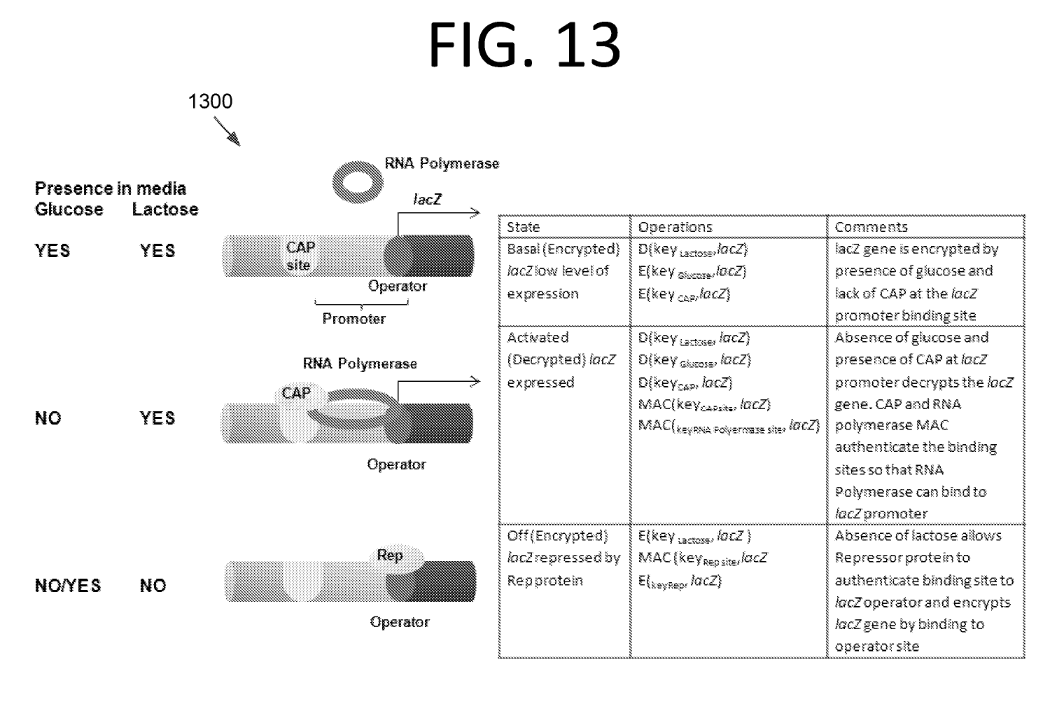

The following relationships can be observed between the cryptographic treatment of messages and control of gene expression. In the case of gene expression, the message is genomic (DNA or RNA sequence). Cryptography transforms messages between two states: plain and encrypted. Cryptography uses operations such as circular shifts, bit expansions, bit padding, arithmetic operations to create ciphertext. These operations have analogs in molecular biology (e.g., transposable elements). Cells transform DNA sequences in genes between two states: expressed (decrypted) and silent (encrypted). In prokaryotes, a simple system involving operators and repressors can be described in terms of encryption and decryption, but prokaryotes have fewer mechanisms available for a rich set of cryptographic protocols. FIG. 13 illustrates a conceptual example 1300 of confidentiality and authentication in E. coli using lacZ expression, according to an embodiment of the present invention.

In this prokaryotic example from E. coli, the lacZ gene expresses the β-galactosidase enzyme when lactose is present and the simple sugar glucose is absent. β-galactosidase metabolizes lactose into glucose and galactose. It would be inefficient to express the enzyme above a trace level if glucose is present. FIG. 13 provides a cryptographic analogy to the states of the lacZ gene under the various conditions of glucose and lactose present, lactose present, and lactose absent. The lacZ gene is encrypted when lactose is absent or both lactose and glucose are present. A repressor protein (rep) authenticates (binds) to the encryption site (lacZ operator) on the lacZ gene with lactose is absent. A catabolite activator protein (CAP) authenticates (binds) to the decryption site (CAP site), allowing RNA polymerase to decrypt (express) the lacZ gene when glucose is absent. All of these operations are shown as analogies to elements of cryptographic message traffic in operations shown in FIG. 13. It is possible to write the description of the gene expression sequence in FIG. 13 in terms of a series of messages between a Sender and Receiver.

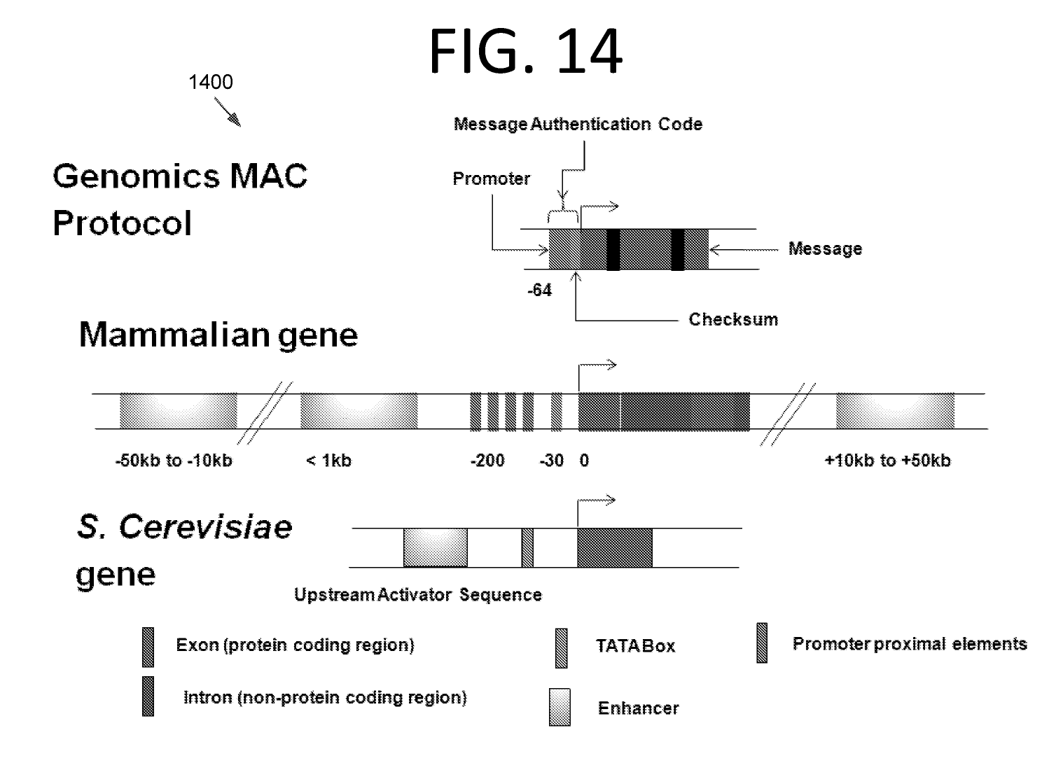

FIG. 14 shows the architecture of the DNA HMAC (without all the required control regions) and its comparison 1400 between gene transcriptional control structures for a typical mammalian gene and a simple, yet important, eukaryote, yeast (S. Cerevisiae). The DNA HMAC structure preserves the intent of the design to mimic a genomic transcriptional control structure.

A successful, in vivo instantiation of a DNA HMAC system generally requires specific stop codons, start codons, promoters and enhancer sequences. An in vivo DNA encryption system should be multi-dimensional, utilize primary, secondary and tertiary structural information, and include up/downstream regulators such that a single sequence can be seamlessly implemented at the genomic level and have multiple levels of encryption at the message or data level, depending upon the context (only known between Sender and Receiver). This approach also permits generation of mutant hash codes, which can be evaluated for fitness such that only the best hash code is selected for authentication purposes.

Epigenetic Relationships Between Cryptography and Gene Expression

Epigenetics involves heritable control of gene expression that does not involve modifications of the underlying DNA sequence. Examples of epigenetic effects include DNA methylation of cytosine residues and control of gene expression via the higher order structures of DNA. In eukaryotes, DNA is packed into a hierarchy of structures: nucleosomes→chromatin→chromosomes. Chromatin states can also be utilized as a form of encryption and decryption by exposing or not exposing genes for transcription. Examples include Heterochromatin form (encrypted) and Euchromatin form (decrypted), transcriptional memory via modification of chromatin states, and Histone Code. Histone Code is a complex series of regulatory activities, which include histone lysine acetylation by histone acetyl transferase—transcriptionally active chromatin (decrypted); Histone lysine deacetylation by histone deacetylase—transcriptionally inactive (encrypted). Expansion of the cryptographic protocols to include epigenetic operations will increase the richness of the protocols and the options for producing combinations of cipherproteins.

A cryptographic hash code based upon a DNA alphabet and a secure MANET authentication protocol is utilized by some embodiments of the present invention. These codes can be utilized at the network level or application level and can also be implemented directly into genomes of choice to provide a new level of ciphertext communication at the genomic and proteomic level. The DNA-inspired cryptographic coding approach is an option in developing true MANET architectures and developing novel forms of biological authentication to augment those architectures.

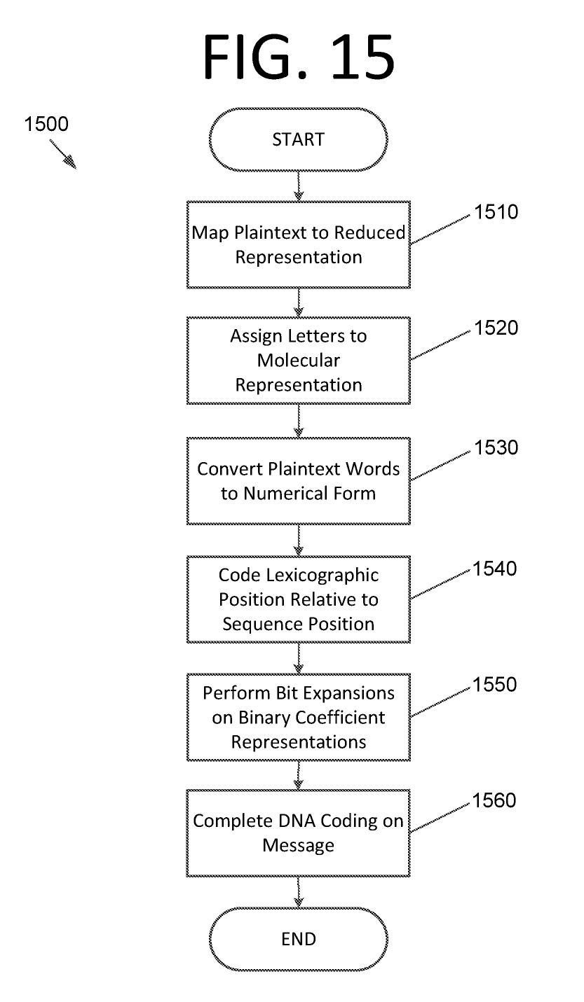

FIG. 15 is a flowchart 1500 illustrating a method for implementing a genomics-based keyed HMAC, according to an embodiment of the present invention. The method may be implemented, for example, by the system 100 of FIG. 1. The method begins with mapping a plaintext message stored in the memory to a reduced representation comprising an alphabet of q letters, where q is an integer, at 1510. Each of the q letters is then assigned to a molecular representation at 1520. The value of each letter may be based on a representation of a function in molecular biology. For example, the value of q may be 4 and the alphabet may be a genomic alphabet corresponding with a set of DNA bases A, T, C and G in some embodiments.

Plaintext words are converted to numerical form at 1530. The plaintext words may be coded such that a lexicographic order is maintained between the words. The lexicographic position of each word relative to the sequence position of each word is coded at 1540. For example, the letters to may be assigned to DNA base sequences in order of frequency of letter appearance such that the letter that appears most frequently has the shortest DNA sequence and the letter that appears least frequently has the longest DNA sequence in order to reduce code size. The lexicographic position of each word may be coded using a system of linear equations.

Bit expansions are performed on a binary representation of a coefficient corresponding with concatenated sequences for each word in the message at 1550. Coding on the message is completed by XOR operations and bit expansions to maintain a base coding depending on the molecular representation at 1560.

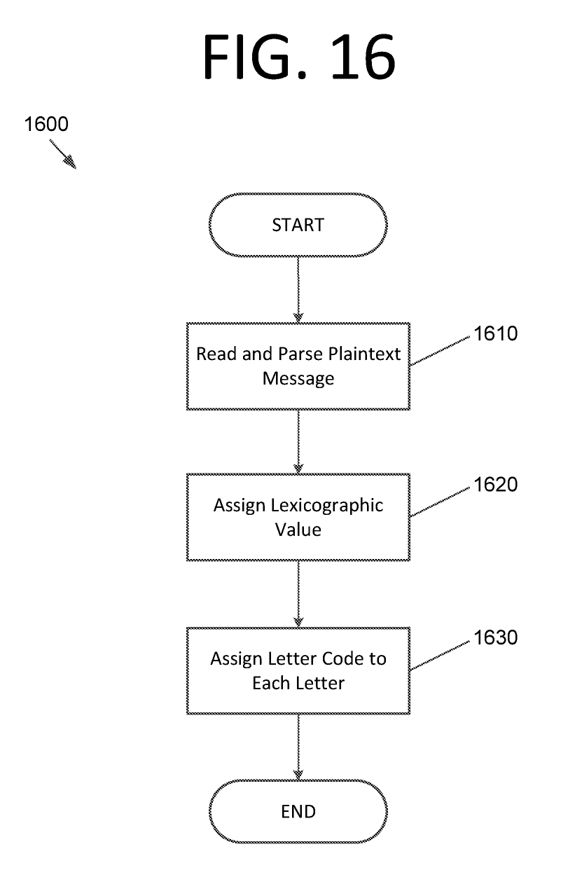

FIG. 16 is a flowchart 1600 illustrating a method for implementing a keyed HMAC system based on concepts from molecular biology, according to an embodiment of the present invention. The method may be implemented, for example, by the system 100 of FIG. 1. The method begins by reading and parsing a plaintext message including a string of words at 1610. A lexicographic value is then assigned to each word in the string to code each word in a rational number at 1620. In some embodiments, the letter code may include A, C, T and G, representing the four bases of DNA. The four DNA bases may be represented by binary sequences. In some embodiments, when more letter codes are required than can be represented by two letters, two-letter codes may be assigned for the most commonly occurring words and three-letter codes may be used for all other words once the unique two-letter codes are exhausted. The method then proceeds to assigning a letter code to each letter at 1630. The letter code for each letter corresponds with a function in molecular biology.

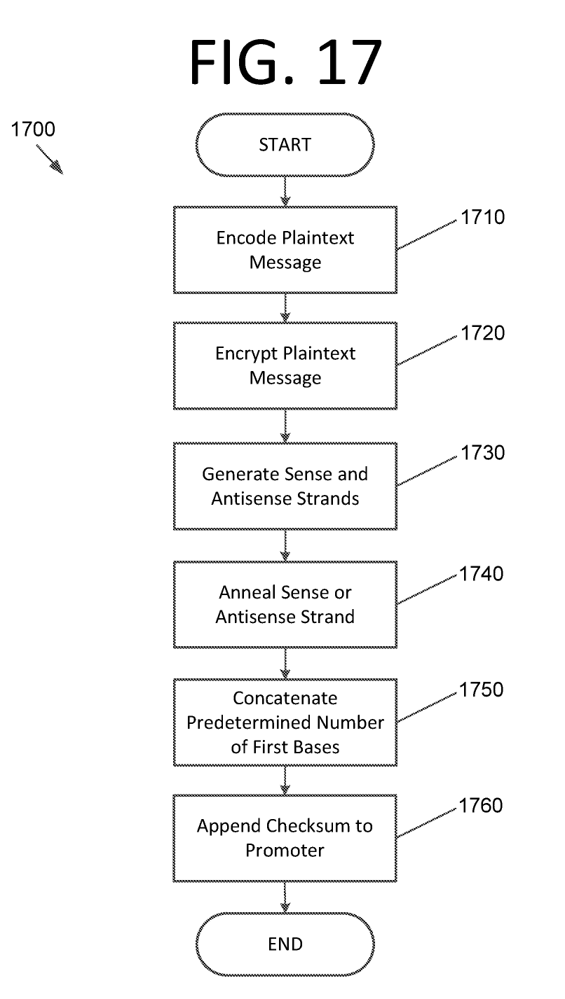

FIG. 17 is a flowchart 1700 illustrating a protocol for message authentication, according to an embodiment of the present invention. The method may be implemented, for example, by the system 100 of FIG. 1. The method begins with encoding a plaintext message into DNA code using word blocks at 1710. In some embodiments, the plaintext message may be encoded into DNA code in three word blocks. Different chromosome segments may be used to encrypt each three word block. The plaintext message is then encrypted with a pre-shared secret chromosome key at 1720.

Sense and antisense strands are generated based on the encrypted plaintext message at 1730. The sense strand or the antisense strand is annealed at 1740, removing transitional bases. A predetermined number of the first bases are concatenated from a predetermined number of the first word blocks to create a promoter at 1750. For example, in some embodiments, the first 64 DNA bases may be concatenated from the first nine word blocks. Thereafter, a checksum is appended to the promoter at 1760. The promoter ∥ (concatenated to) the checksum is a hash code.

In some embodiments, the promoter and checksum may be configured such that a receiver must have a complement of the promoter sequence and an exact match of the checksum to decode the message. In certain embodiments, a sender and a receiver must have a pre-shared secret of a genome and a location of a first base of the sequence to properly encrypt and decrypt messages. The genome of the bacterium M. genitalium may be used to implement the protocol, for example.

In some embodiments, a system for network authentication provides for biological authentication. Biological authentication may be accomplished via an encrypted pattern of gene expression. If correctly decrypted (i.e., correct genes expressed), fluorescent labels on the gene expression products and/or genes may be detected and compared to a known, secretly held pattern of fluorescence that is unique for each authorized user. Libraries of authorized user credentials stored in the form of fluorescent images could be created. Authorization may occur through pattern recognition of the stored authorization credentials against the real time fluorescence emission pattern created at authentication. Such a technique could also be used by a certificate authority (CA). The CA may have the libraries of stored credentials and Network Authentication BioID chips.

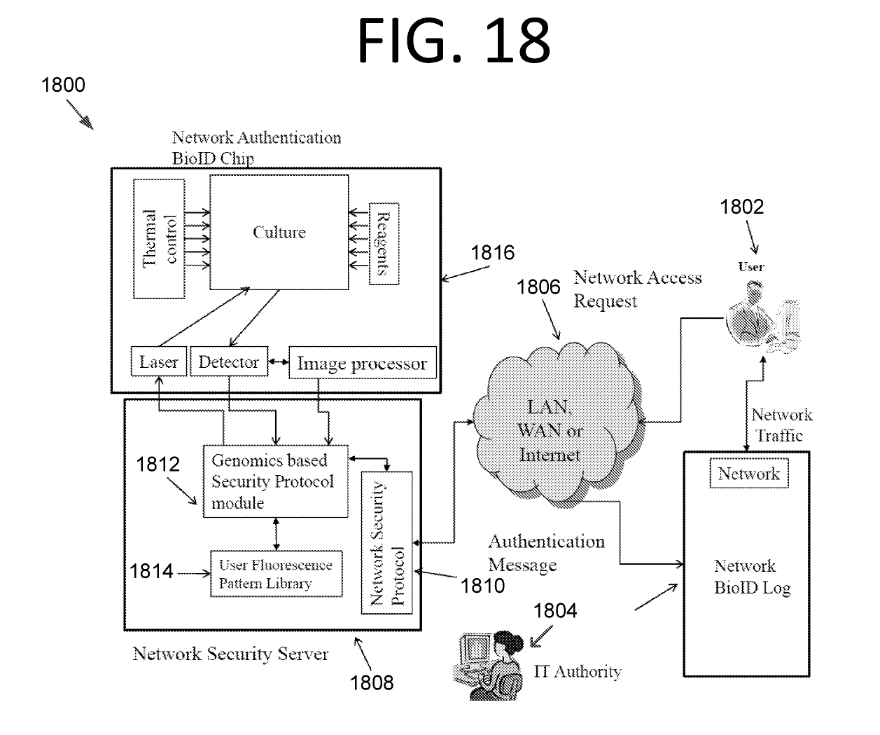

FIG. 18 illustrates a system 1800 in which personnel requiring access to a secure network can be subjected to two phases of authentication. One phase is a biological authentication using aspects of a selected genome. In this example, the selected genome is M. genitalium—a simple prokaryotic genome. This can also be accomplished using eukaryotic genomes such as S. cerevisiae (yeast).

A user 1802 represents a person requiring access to a secure network. User 1802 may be an employee of a multinational organization and once hired, user 1802 may be geographically isolated from the management of the company. An IT Authority 1804 represents an individual with responsibility of maintaining IT security for the network. User 1802 possesses secret information for network access and authentication purposes. This information may include a secret passphrase and genome authentication sequence start position information, such as the starting point of the genomic key specific to the identity of user 1802. User 1802 need not possess any other information and need not possess any contextual information about the form of authentication being used is this embodiment. User 1802 need not know that biological authentication is being used. Further, in this embodiment, the DNA of user 1802 is not involved.

IT Authority 1804 possesses a secret passphrase containing a gene expression protocol (GEP) that forms part of the two phase authentication process. IT Authority 1804 need not know any information about the secret passphase or its context. Electronic authentication proceeds with the secret passphrase and genome start position of user 1802 being combined with the IT Authority secret GEP. This combination is used to create a transfection vector to be incorporated into the target genome (in this case, M. genitalium). The transfection vector is applied to the target genome and the bacteria are applied to a culture medium in a specific pattern as specified in the GEP, then cultured. The pattern of gene expression is verified and the cultures are stored for future authentication purposes. The same information is used to create a DNA HMAC that is created from a message containing the secret GEP.

In FIG. 18, user 1802 performs a network access request through LAN, WAN or Internet 1806. The network access request is routed to a network security server 1808 via an existing network security protocol 1810. Network security server 1808 contains a Genomics based Security Protocol Module 1812 and a User Fluorescence Pattern Library 1814. Genomics based Security Protocol Module 1812 issues control instructions to a Network Authentication BioID Chip 1816 that contains the necessary elements. In some embodiments, this may include a laser to excite fluorescence emission at a target wavelength, a detector (camera and optics) to image the fluorescence pattern, a thermal control system for heating and cooling the device, reagents necessary for genes expression and fluorescence detection, and an image processor to compare the stored and generated patterns with a culture consisting of the cells containing the encrypted genomic structures waiting to be expressed.

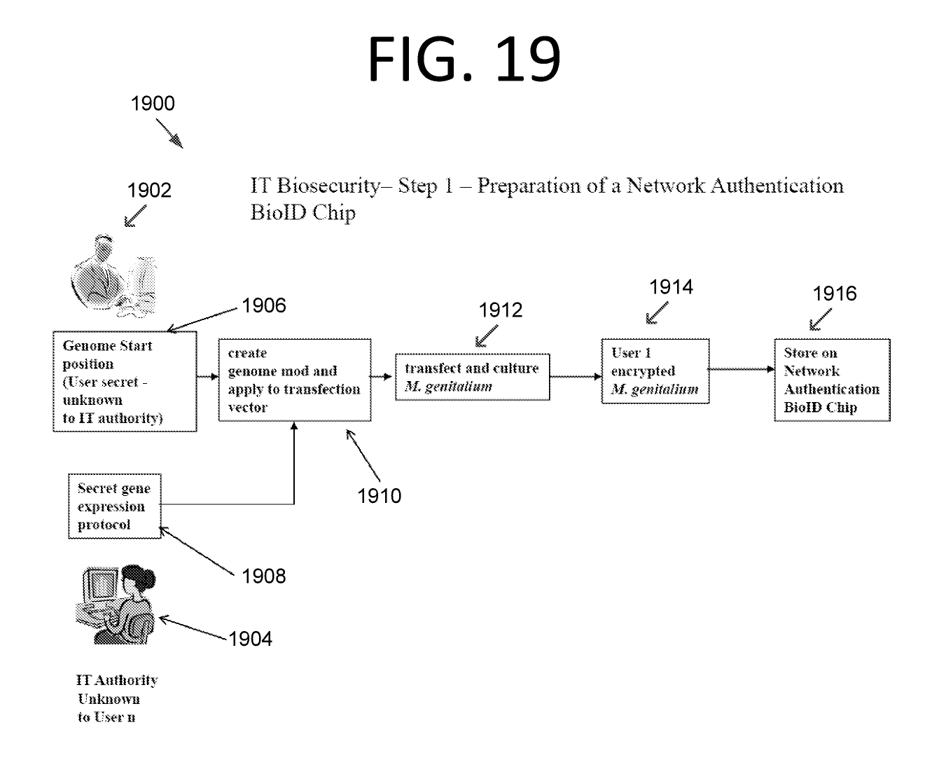

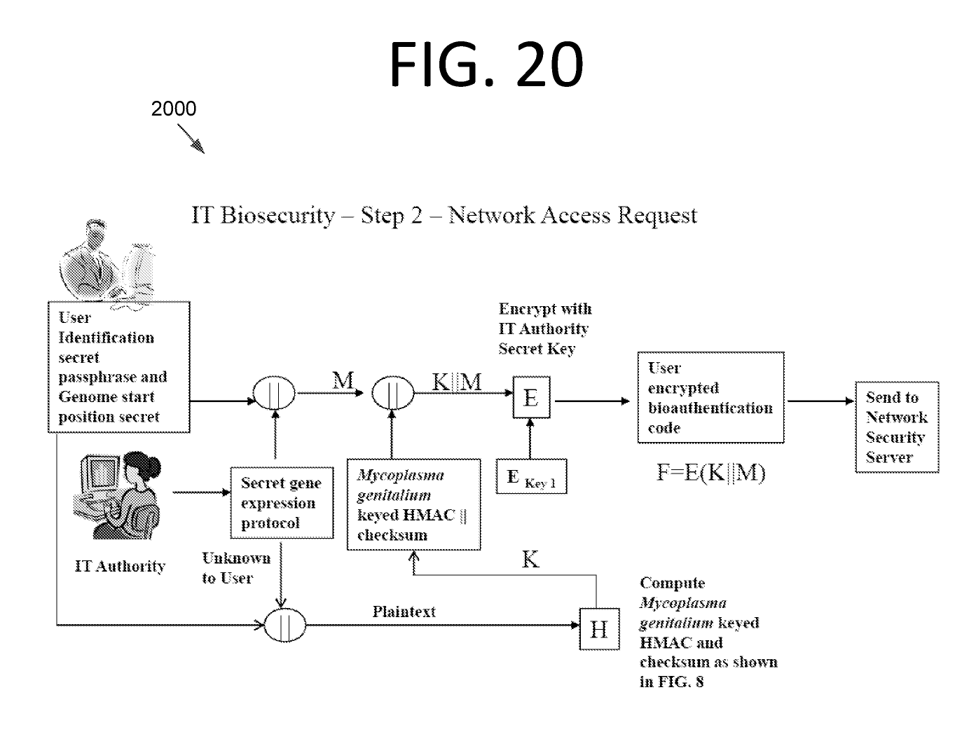

Genomics based Security Protocol Module 1812 determines whether the criteria for bioauthentication have been met and issues authorization messages to network security protocol 1810 such that authentication is either granted or denied in a transaction analogous to password processing. Network security protocol 1810 (e.g., IPsec) handles the security transactions and interfaces with users. A three step process for bioauthentication is discussed in more detail in FIGS. 19-22 below.

FIG. 19 illustrates the generation of a Network Authentication BioID Chip 1900. User 1902 is issued a number or a passphrase tied to a number to indicate a starting location within a genome at 1906. This genome location is combined with a secret genome expression protocol at 1908. A simplified example of a genome expression protocol would be taking a heat shock consensus upstream element from a heat inducible gene and transfecting the element to a secret location on a non-heat-inducible gene. To express the gene, the temperature is raised to the new expression range. A genome modification is created and a transfection vector is applied at 1910. M. genitalium is transfected and cultured at 1912 and the encrypted M. genitalium of user 1902 is produced at 1914. The encrypted information is then stored on a Network Authentication BioID Chip at 1916. The Network Authentication BioID Chip contains the necessary fluorescent expression tags for post translation observation.

Neither user 1902 nor IT security personnel 1904 require any knowledge of how the system works, the genomes involved, or the decision making process. In other words, these operations are a “black box” to these individuals.

FIG. 20 illustrates a network access process 2000 that could be used for activities such as sending authentication requests or messages. This example uses symmetric encryption. However, asymmetric encryption and public/private key pairs will also accomplish the required functions. The more detailed process of message processing is as shown in FIG. 5.

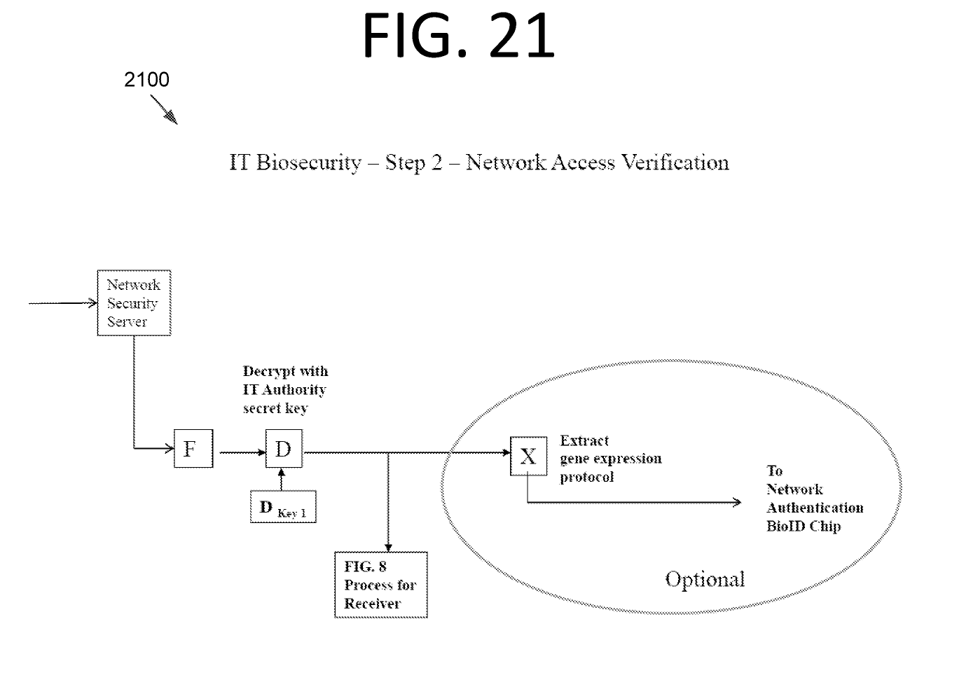

FIG. 21 illustrates the network response in access verification 2100. Symmetric decryption, followed by the processes of FIG. 8, occur at the receiver. Optionally, the processes of bioauthentication can be implemented if the Network Authentication BioID Chip scheme has been implemented.

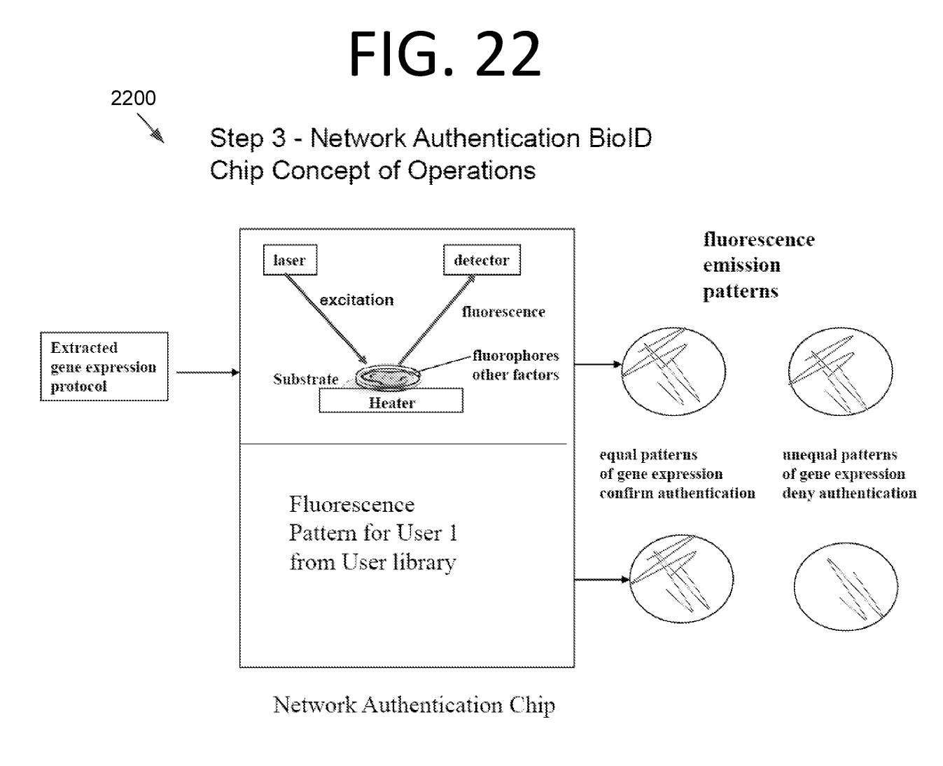

FIG. 22 illustrates the concept of operation 2200 of the Network Authentication BioID Chip. In this example, if the proper authentication sequence has been provided, the culture is raised to the expression level of the heat shock inducible gene in its new genome, the correct fluorescence tag is applied, and laser-induced fluorescence occurs, providing a fluorescence pattern matching the one stored for the user. An authentication message is sent back the network security protocol and normal authentication processes are initiated.

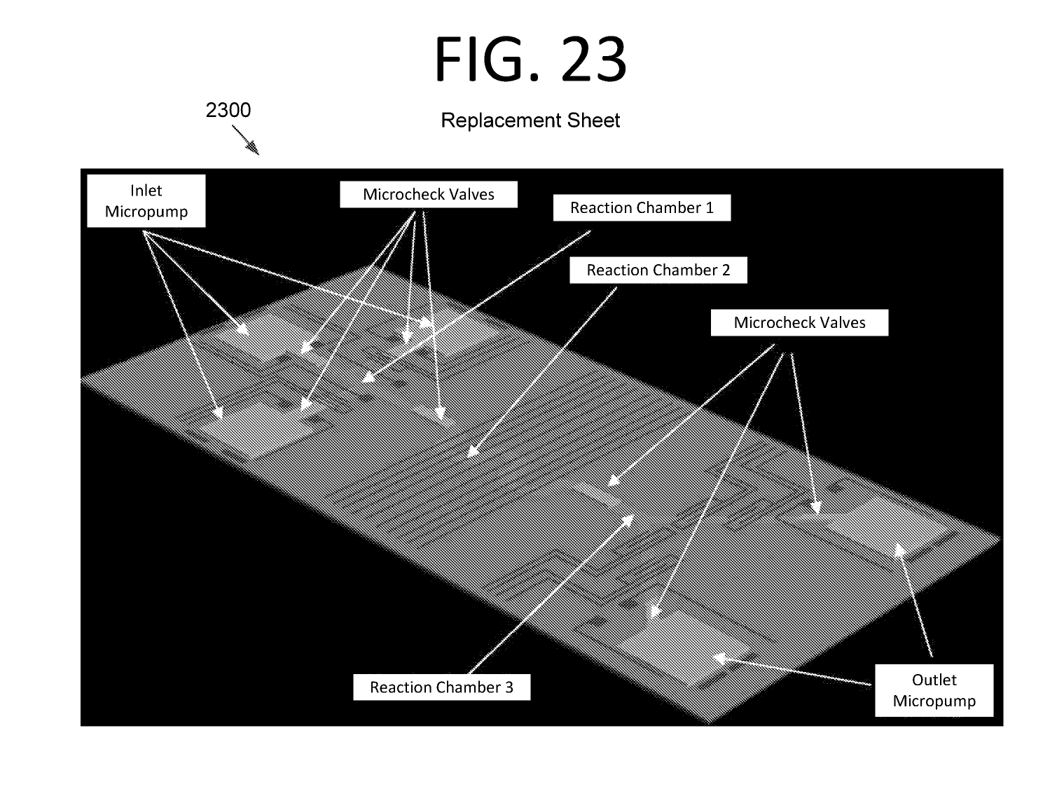

FIG. 23 illustrates a laboratory on a chip 2300 capable of providing the functions necessary for a Network Authentication BioID Chip. A hybrid microelectronic package utilizing this basic design integrated with one or more Vertical Cavity Surface Emitting Lasers (VCSEL), CCD detectors and simple optics, and a microprocessor to perform the image processing and control functions for the device are included.

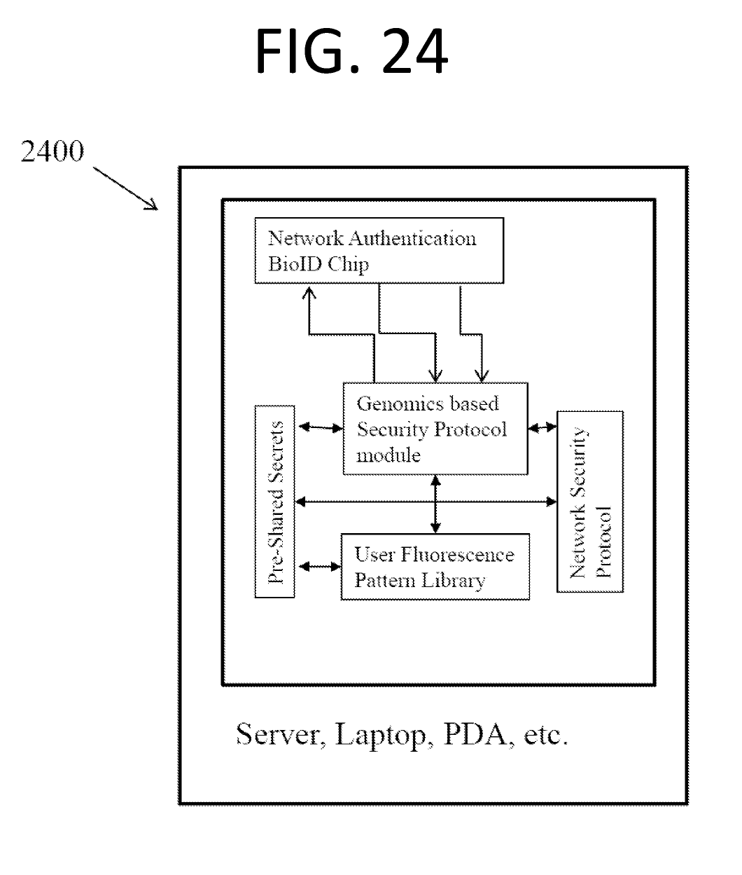

FIG. 24 illustrates a genomics security module 2400 and its interfaces, according to an embodiment of the present invention. The devices are integrated into a single module suitable for interfacing with laptops, servers, routers, firewalls, PDA, and other devices for which network security is required.

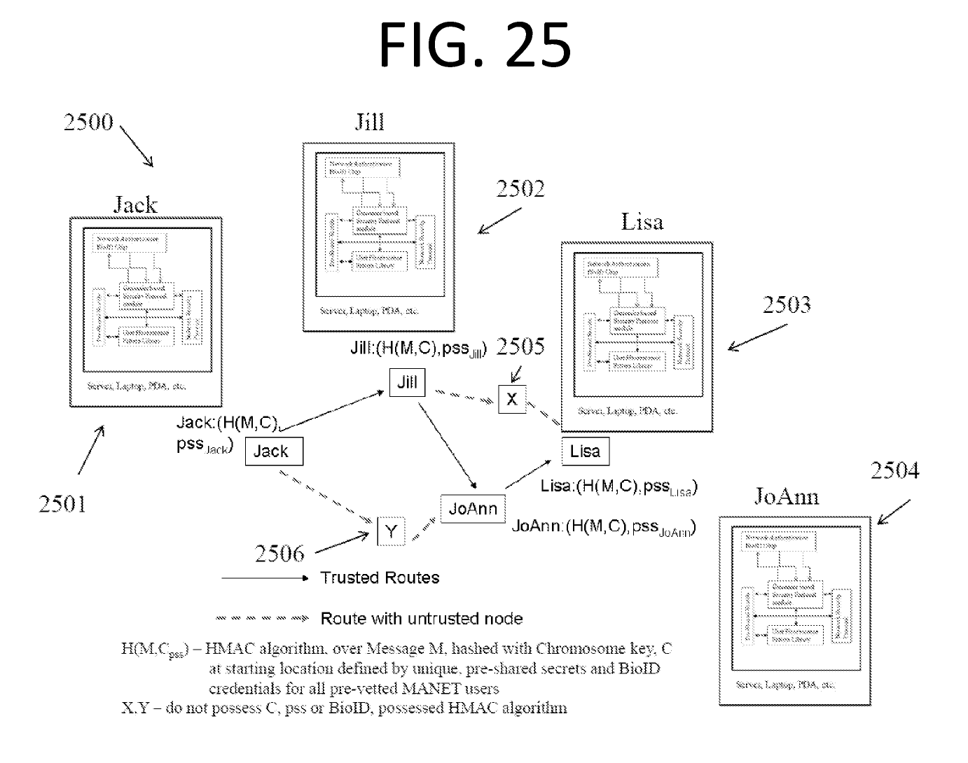

FIG. 25 illustrates a MANET 2500 with implementation of a genomics security module. Users 2501, 2502, 2503, and 2504 possess the genomics security modules and the proper pre-shared secrets provide two levels of network authentication to participate in a communication session. Users 2505 and 2506 lack the genomics security module for authentication have their authentication requests, route requests and acknowledgements ignored by the other MANET users. In this embodiment, the genomics security protocol communicates with the network security protocols and dynamic source routing protocols to establish and maintain secure routing for the MANET users.

The method steps performed in FIGS. 2 and 15-17 may be performed by a computer program product, encoding instructions for the nonlinear adaptive processor to perform at least the methods described in FIGS. 2 and 15-17, in accordance with an embodiment of the present invention. The computer program product may be embodied on a computer readable medium. A computer readable medium may be, but is not limited to, a hard disk drive, a flash device, a random access memory, a tape, or any other such medium used to store data. The computer program product may include encoded instructions for controlling the nonlinear adaptive processor to implement the methods described in FIGS. 2 and 15-17, which may also be stored on the computer readable medium.

The computer program product can be implemented in hardware, software, or a hybrid implementation. The computer program product can be composed of modules that are in operative communication with one another, and which are designed to pass information or instructions to display. The computer program product can be configured to operate on a general purpose computer, or an application specific integrated circuit (“ASIC”).

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. An apparatus configured to implement a genomics-based keyed hash message authentication code, comprising:
a processor and memory storing computer program instructions, wherein the computer program instructions are configured to cause the processor to:
map a plaintext message stored in the memory to a reduced representation comprising an alphabet of q letters, where q is an integer,
assign each of the q letters to a molecular representation,
convert plaintext words to numerical form, and
code a lexicographic position of each word relative to a sequence position of each word.

2. The apparatus of claim 1, wherein a value of q is based on a representation of a function in molecular biology.

3. The apparatus of claim 2, wherein the value of q is 4 and the alphabet is a genomic alphabet corresponding with a set of DNA bases A, T, C and G.

4. The apparatus of claim 3, wherein the assigning of letters to DNA base sequences comprises assigning DNA sequences in order of frequency of letter appearance such that the letter that appears most frequently has the shortest DNA sequence and the letter that appears least frequently has the longest DNA sequence in order to reduce code size.

5. The apparatus of claim 1, wherein in the conversion of plaintext words to numerical form, the plaintext words are coded such that a lexicographic order is maintained between the words.

6. The apparatus of claim 1, wherein the computer program instructions are further configured to cause the processor to code of the lexicographic position of each word using a system of linear equations.

7. The apparatus of claim 1, wherein the computer program instructions are further configured to cause the processor to:
perform bit expansions on a binary representation of a coefficient corresponding with concatenated sequences for each word in the message, and
complete coding on the message by XOR operations and bit expansions to maintain a base coding depending on the molecular representation.

8. A computer-implemented method performed by a physical computing device, comprising:
reading and parsing a plaintext message comprising a string of words;
assigning a lexicographic value to each word in the string to code each word in a rational number; and
assigning a letter code to each letter, wherein the letter code for each letter corresponds with a function in molecular biology.

9. The computer-implemented method of claim 8, wherein the letter code comprises A, C, T and G, representing the four bases of DNA.

10. The computer-implemented method of claim 8, wherein when more letter codes are required than can be represented by two letters, two-letter codes are assigned for the most commonly occurring words and three-letter codes are used for all other words once the unique two-letter codes are exhausted.

11. The computer-implemented method of claim 8, wherein the four DNA bases are represented by binary sequences.

12. A computer program embodied on a non-transitory computer-readable medium, the computer program configured to cause a processor to:
encode a plaintext message into DNA code using word blocks;
encrypt the plaintext message with a pre-shared secret chromosome key; and
generate sense and antisense strands based on the encrypted plaintext message.

13. The computer program of claim 12, wherein the plaintext message is encoded into DNA code in three word blocks.

14. The computer program of claim 12, wherein the program is further configured to cause the processor to anneal the sense strand or the antisense strand, removing transitional bases.

15. The computer program of claim 12, wherein the program is further configured to cause the processor to concatenate a predetermined number of the first bases from a predetermined number of the first word blocks to create a promoter.

16. The computer program of claim 12, wherein the program is further configured to cause the processor to append a checksum to the promoter, wherein the promoter concatenated to the checksum is a hash code.

17. The computer program of claim 12, wherein the promoter and checksum are configured such that a receiver must have a complement of the promoter sequence and an exact match of the checksum to decode the message.

18. The computer program of claim 12, wherein a sender and a receiver must have a pre-shared secret of a genome and a location of a first base of the sequence to properly encrypt and decrypt messages.

19. The computer program of claim 12, wherein the program is configured to use the genome of the bacterium M. genitalium.

20. The computer program of claim 12, wherein the program is configured to compare predetermined fluorescence images of gene expression with candidate images for authentication and output a result that either confirms or denies an image match within a user-selectable probability of error.


SEQUENCE LISTING (18 sequences)

SEQ ID NO: 1 - DNA, 16 bp, Artificial Sequence
  Cryptographic sequence created by algorithm
cacaatggtagcacgg

SEQ ID NO: 2 - DNA, 512 bp, Artificial Sequence
  Cryptographic sequence created by algorithm
aattctaagttcccgcccgtcggtccgccgcccgtccggtccgccgcccgtcccggtccgccgcaatctcaattctcgcccgtcggtccgccgcccgtccggtccgccgcccgtcccggtccgccgccaactccaatcttgcccgtcggtccgccgcccgtccggtccgccgcccgtcccggtccgccgcccaatccgaacttccccgtcggtccgccgcccgtccggtccgccgcccgtcccggtccgccgcccgaaccgtaattctccgtcggtccgccgcccgtccggtccgccgcccgtcccggtccgccgcccgtaacgttaatcttcgtcggtccgccgcccgtccggtccgccgcccgtcccggtccgccgcccgtcaagttcaactttaatccgaacttcaatcgtaacgttaatctttcgtttaagttcaactttaattaattctaatttcaaccgtaattctaacgttaagttcaactttcgtttcaattctaatttcaatc

SEQ ID NO: 3 - DNA, 63 bp, Artificial Sequence
  Cryptographic sequence created by algorithm
aaaaaatgatggtccgccagtgcccggctctccaatgcctgaatcagatggagagattctggc

SEQ ID NO: 4 - DNA, 64 bp, Mycoplasma genitalium
taagttattatttagtaagttattatttagttaagttattatttagtttaagttattatttagt

SEQ ID NO: 5 - DNA, 64 bp, Artificial Sequence
  Cryptographic sequence created by algorithm
aaaaaacgatggctggcgatctctccgttcccgtaactcctgaaggatagctatagattccctc

SEQ ID NO: 6 - DNA, 64 bp, Mycoplasma genitalium
ttataagttattatttagtaagttattatttagttaagttattatttagtttaagttattattt

SEQ ID NO: 7 - DNA, 64 bp, Artificial Sequence
  Cryptographic sequence created by algorithm
aaaaaaggagggcgggccagtgctccggctcttcaatcgcgtaagtagatccacagagtgtctg

SEQ ID NO: 8 - DNA, 64 bp, Mycoplasma genitalium
aagttattatttagttaagttattatttagtttaagttattatttagttataagttattattta

SEQ ID NO: 9 - DNA, 64 bp, Artificial Sequence
  Cryptographic sequence created by algorithm
aaaaaaggaggtttgtgtagcgtttgggccctcgaaccggcgaaggagagggagatatcttccc

SEQ ID NO: 10 - DNA, 64 bp, Mycoplasma genitalium
gttaagttattatttagtttaagttattatttagttataagttattatttagttaataagttat

SEQ ID NO: 11 - DNA, 10 bp, Mycoplasma genitalium
ttataagtaa

SEQ ID NO: 12 - DNA, 10 bp, Mycoplasma genitalium
aatattcatt

SEQ ID NO: 13 - DNA, 10 bp, Mycoplasma genitalium
ggggggccgc

SEQ ID NO: 14 - DNA, 10 bp, Mycoplasma genitalium
ccccccggcg

SEQ ID NO: 15 - DNA, 11 bp, Artificial Sequence
  Cryptographic sequence created by algorithm
gcgctaaccgc

SEQ ID NO: 16 - DNA, 15 bp, Mycoplasma genitalium
ggtcaacgtgaacct

SEQ ID NO: 17 - DNA, 15 bp, Mycoplasma genitalium
ggtcaacgtgaacct

SEQ ID NO: 18 - DNA, 537 bp, Mycoplasma genitalium
cgcgccctttgacagcagttagttgctgactcggatgcagagagtcggtaacaccttctccaacgagagccgggtggcatcccggtgtcccagcgtgggccttgctgaacggaaccgggtggccacaatgccggtgcggctgctcagggacagtccagcggctcaggaggacaatgaccatgccagagacggtttccaaatgaagctggatgcccacggcttcgccccggaggaactggtggtgcaggtggatggccaatggctgatggtgaccggacagcagcaactggacgtgagggacccggaaagggtcagttaccgcatgtcacagaaggtgcaccggaaaatgctcccgtccaacctgagtcctaccgccatgacctgctgcctgaccccctccgggcagctgtgggtcagaggccagtgtgtggcgctggccctccctgaagcccaaacaggaccgtccccgagactcgggagcctcggctctaaggcttccaacctgacccggtaaacaaacgacgcgatgtgcagcag